(19) United States
(12) Patent Application Publication
(10) Pub. No.: US 2026/0118790 A1
(43) Pub. Date: Apr. 30, 2026

(54) ELECTROPHOTOGRAPHIC APPARATUS

(71) Applicant: CANON KABUSHIKI KAISHA, Tokyo (JP)

(72) Inventors: NAOAKI ICHIHASHI, Chiba (JP); KENICHI IKARI, Chiba (JP); HARUHIKO MITSUDA, Chiba (JP); KENTARO KAMAE, Kanagawa (JP)

(21) Appl. No.: 19/003,455

(22) Filed: Dec. 27, 2024

(30) Foreign Application Priority Data
Jan. 5, 2024 (JP) 2024-000891
Oct. 8, 2024 (JP) 2024-176752

(51) Int. Cl. G03G 9/087; G03G 9/097

(52) U.S. Cl. CPC G03G 9/08755; G03G 9/08733; G03G 9/09725

(57) ABSTRACT

The electrophotographic apparatus includes: an electrophotographic photosensitive member; a charging unit configured to charge a surface of the electrophotographic photosensitive member; an image exposing unit configured to form an electrostatic latent image on the surface of the electrophotographic photosensitive member; a developing unit configured to form a toner image on the surface of the electrophotographic photosensitive member; a transfer unit configured to transfer the toner image from the surface of the electrophotographic photosensitive member onto a transfer material; and a cleaning unit configured to remove a residual toner remaining on the surface of the electrophotographic photosensitive member. The electrophotographic photosensitive member includes a surface layer containing a compound represented by the formula (A), a binder resin, and silicon atom-containing particles. The silicon atom-containing particles are one of silica particles or silicone resin particles. The toner includes toner particles each containing a polyester resin having a polyethylene terephthalate segment.

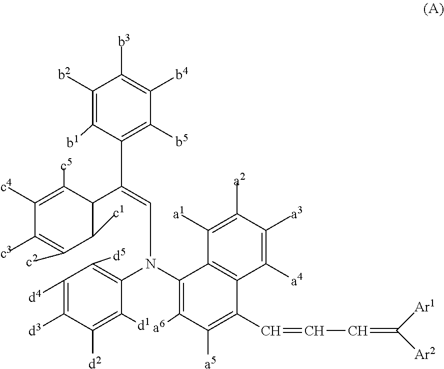

### BACKGROUND OF THE INVENTION

### Field of the Invention

The present disclosure relates to an electrophotographic apparatus.

### Description of the Related Art

In recent years, in an electrophotographic apparatus, there have been various demands, such as an increase in speed, a reduction in size, and energy savings. In an electrophotographic photosensitive member to be used in the electrophotographic apparatus, there has been a demand for an increase in sensitivity corresponding to the increase in speed. For example, in Japanese Patent Application Laid-Open No. 2005-115077, there is a description of a technology that provides a high-sensitivity electrophotographic photosensitive member through use of an enamine-based compound as a charge-transporting substance.

In addition, in order to achieve an energy-saving electrophotographic apparatus, there has been proposed a technology for fixing a toner at low temperature. In Japanese Patent Application Laid-Open No. 2004-280085, there is a description of a technology regarding a toner containing, as one of resin components, a polyester obtained by causing polyethylene terephthalate, an alcohol component, and a carboxylic acid component to react with each other.

### SUMMARY OF THE INVENTION

However, when the technologies described in Japanese Patent Application Laid-Open No. 2005-115077 and Japanese Patent Application Laid-Open No. 2004-280085 are used in combination, there has been room for improvement at the time of repeated use under a high-temperature and high-humidity environment. That is, a light potential difference occurs between a portion on the electrophotographic photosensitive member in which printing is repeated and the other portions at the time of the formation of an electrostatic latent image on the electrophotographic photosensitive member, and image density unevenness (pattern memory) may occur.

The present disclosure is directed to provide an electrophotographic apparatus in which the occurrence of image density unevenness (pattern memory) at the time of repeated use under a high-temperature and high-humidity environment is suppressed.

According to the present disclosure, there is provided an electrophotographic apparatus including: an electrophotographic photosensitive member; a charging unit configured to charge a surface of the electrophotographic photosensitive member; an image exposing unit configured to irradiate the charged surface of the electrophotographic photosensitive member with image exposure light to form an electrostatic latent image on the surface of the electrophotographic photosensitive member; a developing unit, which includes a toner, and which is configured to develop the electrostatic latent image with the toner to form a toner image on the surface of the electrophotographic photosensitive member; a transfer unit configured to transfer the toner image from the surface of the electrophotographic photosensitive member onto a transfer material; and a cleaning unit configured to remove a residual toner remaining on the surface of the electrophotographic photosensitive member after the toner image is transferred from the surface of the electrophotographic photosensitive member onto the transfer material, wherein the electrophotographic photosensitive member includes a surface layer containing a compound represented by the following formula (A), a binder resin, and silicon atom-containing particles, wherein the silicon atom-containing particles are one of silica particles or silicone resin particles, and wherein the toner includes toner particles each containing a polyester resin having a polyethylene terephthalate segment:

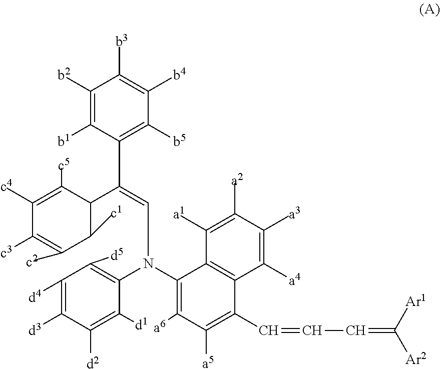

in the formula (A), a¹ to a⁶ each independently represent a hydrogen atom, a halogen atom, a substituted or unsubstituted alkyl group, a substituted or unsubstituted alkoxy group, a dialkylamino group, or a substituted or unsubstituted aryl group, or may be bonded to each other to form a ring structure, b¹ to b⁵, c¹ to c⁵, and d¹ to d⁵ each independently represent a hydrogen atom, a halogen atom, a substituted or unsubstituted alkyl group, a substituted or unsubstituted alkoxy group, a dialkylamino group, a substituted or unsubstituted aryl group, a substituted or unsubstituted aryloxy group, or a substituted or unsubstituted arylthio group, or may be bonded to each other to form a ring structure, and Ar¹ and Ar² each independently represent a hydrogen atom, a substituted or unsubstituted alkyl group, a substituted or unsubstituted aryl group, a substituted or unsubstituted aralkyl group, or a substituted or unsubstituted heterocyclic group, or may be bonded to each other to form a ring structure, provided that Ar¹ and Ar² are prevented from both representing hydrogen atoms.

Further features of the present invention will become apparent from the following description of exemplary embodiments with reference to the attached drawings.

### BRIEF DESCRIPTION OF THE DRAWINGS

FIG. 1 is a schematic view for illustrating an example of the configuration of an electrophotographic photosensitive member.

FIG. 2 is a schematic view for illustrating an example of an electrophotographic apparatus including the electrophotographic photosensitive member.

### DESCRIPTION OF THE EMBODIMENTS

Investigations made by the inventors have found that, when a surface layer of an electrophotographic photosensitive member contains a compound represented by the formula (A), a binder resin, and silicon atom-containing particles, and a toner includes toner particles each containing a polyester resin having a polyethylene terephthalate segment, the occurrence of image density unevenness (pattern memory) at the time of repeated use under a high-temperature and high-humidity environment can be suppressed.

The inventors have assumed the reasons for which an electrophotographic apparatus of the present disclosure is excellent in suppressing effect on the occurrence of image density unevenness at the time of repeated use under a high-temperature and high-humidity environment to be as described below.

It has been known that the compound represented by the formula (A) is a kind of enamine-based compound and is used as a high-sensitivity charge-transporting substance in the electrophotographic photosensitive member. However, the compound also has such a feature that its sensitivity is easily changed by a change in humidity.

Meanwhile, the toner having the polyethylene terephthalate segment tends to have high polarity as compared to a polyester resin that is generally used in a toner, and hence the affinity for water thereof tends to be increased. As a result, when a toner is present on the surface of the electrophotographic photosensitive member, the amount of moisture on the surface of the electrophotographic photosensitive member becomes higher than the amount of moisture in air under a usage environment. When the electrophotographic apparatus is used under a high-temperature and high-humidity environment, such influence becomes significant.

When an image is formed through use of the electrophotographic photosensitive member containing the enamine-based compound represented by the formula (A) in the surface layer and the toner containing the polyester resin having the polyethylene terephthalate segment under a high-temperature and high-humidity environment, the amount of moisture present on the surface of the toner having high polarity is increased, and hence the amount of moisture present on the surface of the electrophotographic photosensitive member that is brought into contact with the toner is also increased. When a solid black band image is output, the amount of the toner present on the surface of the electrophotographic photosensitive member is increased, and hence the influence of an increase in amount of moisture on the surface of the electrophotographic photosensitive member is also increased. It is conceived that the moisture on the surface of the electrophotographic photosensitive member influences the sensitivity of the charge-generating substance, resulting in a sensitivity difference between a solid black band portion and a solid white band portion in the electrophotographic photosensitive member. It is conceived that, when another pattern image is output under a state in which a sensitivity difference has remained as described above, a density difference occurs in an image portion with no need of the occurrence of the density difference, and this density difference appears on the image as a pattern memory.

The inventors have made investigations, and as a result, have found that, when silica particles or silicone resin particles are incorporated as silicon atom-containing particles into the surface layer of the electrophotographic photosensitive member, an electrophotographic apparatus having a pattern memory suppressed is obtained.

The inventors have assumed the reasons for which the electrophotographic apparatus of the present disclosure is excellent in pattern memory-suppressing effect to be as described below.

The surface layer of the electrophotographic photosensitive member of the present disclosure contains the silicon atom-containing particles and the enamine-based compound represented by the formula (A). It is assumed that, in the surface layer of the electrophotographic photosensitive member, the silicon atom-containing particles interposed between the surface and the enamine-based compound suppress the influence of moisture on the enamine-based compound from the surface. When the influence of moisture on the enamine-based compound from the surface is reduced, a change in sensitivity caused by the moisture is decreased, and a pattern memory is suppressed.

The present invention is described in detail below by way of exemplary embodiments.

### <Electrophotographic Photosensitive Member>

An electrophotographic photosensitive member of the electrophotographic apparatus of the present invention is characterized by including a surface layer containing a compound represented by the formula (A), a binder resin, and silicon atom-containing particles.

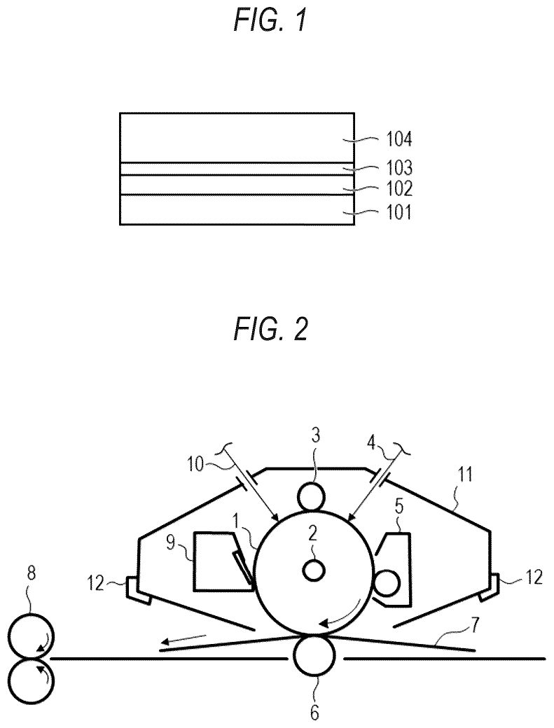

An example of the layer configuration of the electrophotographic photosensitive member of the present disclosure is illustrated in FIG. 1. In FIG. 1, the electrophotographic photosensitive member is formed as a laminate-type photosensitive layer in which an undercoat layer 102, a charge-generating layer 103, and a charge-transporting layer 104 are laminated on a support 101.

In the present invention, the outermost surface layer of the electrophotographic photosensitive member is defined as a surface layer.

An example of a method of producing the electrophotographic photosensitive member of the present disclosure is a method including preparing a coating liquid for each layer described later, applying the liquid in a desired layer order, and drying the liquid. In this case, examples of a method of applying each of the coating liquids include dip coating, spray coating, inkjet coating, roll coating, die coating, blade coating, curtain coating, wire bar coating, and ring coating. Of those, dip coating is preferred from the viewpoints of efficiency and productivity.

Each of the layers is described below.

### <Support>

The support of the electrophotographic photosensitive member is preferably a support having conductivity (conductive support). In addition, examples of the shape of the support include a cylindrical shape, a belt shape, and a sheet shape. Of those, a cylindrical support is preferred. In addition, the surface of the support may be subjected to electrochemical treatment such as anodic oxidation, blast treatment, or cutting treatment.

A metal, a resin, glass, or the like is preferred as a material for the support.

Examples of the metal include aluminum, iron, nickel, copper, gold, stainless steel, and an alloy thereof. Of those, an aluminum support using aluminum is preferred.

In addition, it is preferred that conductivity be imparted to the resin or the glass by treatment, such as mixing or coating with a conductive material.

The surface of the conductive support may be subjected to anodic oxide film treatment, surface treatment with chemicals, hot water, or the like, coloring treatment, or diffuse reflection treatment such as surface roughening, as required, to the extent that image quality is not influenced. The diffuse reflection treatment is particularly effective when the photosensitive member according to the present invention is used in an electrophotographic process using a laser as an exposure light source. That is, in the electrophotographic process using a laser as an exposure light source, the wavelengths of laser light are uniform, and hence the laser light reflected from the surface of the photosensitive member and the laser light reflected inside the photosensitive member cause interference, with the result that an interference fringe caused by the interference may appear on an image to cause an image defect. Thus, the image defect caused by the interference of phase-aligned laser light can be prevented by subjecting the surface of the conductive support to the diffuse reflection treatment.

### <Conductive Layer>

A conductive layer may be arranged on the support. The arrangement of the conductive layer can conceal scratches and irregularities on the surface of the support, and control the reflection of light on the surface of the support.

The conductive layer preferably contains conductive particles and a resin.

A material for the conductive particles is, for example, a metal oxide, a metal, or carbon black.

Examples of the metal oxide include zinc oxide, aluminum oxide, indium oxide, silicon oxide, zirconium oxide, tin oxide, titanium oxide, strontium titanate, magnesium oxide, antimony oxide, and bismuth oxide. Examples of the metal include aluminum, nickel, iron, nichrome, copper, zinc, and silver.

Of those, metal oxide particles are preferably used as the conductive particles, and in particular, titanium oxide particles, tin oxide particles, and zinc oxide particles are more preferably used.

When the metal oxide particles are used as the conductive particles, the surface of each of the metal oxide particles may be treated with a silane coupling agent or the like, or the metal oxide particles may each be doped with an element, such as phosphorus or aluminum, or an oxide thereof.

In addition, each of the conductive particles may have a laminate configuration including a core particle and a coating layer coating the particle. Examples of the core particle include a titanium oxide particle, a barium sulfate particle, and a zinc oxide particle. Examples of the coating layer include metal oxide particles such as tin oxide.

In addition, when the metal oxide particles are used as the conductive particles, the volume-average particle diameter thereof is preferably 1 nm or more and 500 nm or less, more preferably 3 nm or more and 400 nm or less.

Examples of the resin include a polyester resin, a polycarbonate resin, a polyvinyl acetal resin, an acrylic resin, a silicone resin, an epoxy resin, a melamine resin, a polyurethane resin, a phenol resin, and an alkyd resin.

In addition, the conductive layer may further contain a silicone oil, resin particles, a concealing agent such as titanium oxide, and the like.

The conductive layer may be formed by: preparing a coating liquid for a conductive layer containing each of the above-mentioned materials and a solvent; forming a coat thereof on the support; and drying the coat. Examples of the solvent to be used in the coating liquid for a conductive layer include an alcohol-based solvent, a sulfoxide-based solvent, a ketone-based solvent, an ether-based solvent, an ester-based solvent, and an aromatic hydrocarbon-based solvent. Examples of a dispersion method for dispersing the conductive particles in the coating liquid for a conductive layer include methods using a paint shaker, a sand mill, a ball mill, and a liquid collision-type high-speed disperser.

The thickness of the conductive layer is preferably 1 m or more and 50 m or less, particularly preferably 3 m or more and 40 m or less.

### <Undercoat Layer>

In the present disclosure, an undercoat layer may be arranged on the support or the conductive layer. The arrangement of the undercoat layer can improve an adhesive function between layers to impart a charge injection-inhibiting function.

The undercoat layer preferably contains a resin. In addition, the undercoat layer may be formed as a cured film by polymerizing a composition containing a monomer having a polymerizable functional group.

Examples of the resin include a polyester resin, a polycarbonate resin, a polyvinyl acetal resin, an acrylic resin, an epoxy resin, a melamine resin, a polyurethane resin, a phenol resin, a polyvinyl phenol resin, an alkyd resin, a polyvinyl alcohol resin, a polyethylene oxide resin, a polypropylene oxide resin, a polyamide resin, a polyamic acid resin, a polyimide resin, a polyamide imide resin, and a cellulose resin.

Examples of the polymerizable functional group of the monomer having a polymerizable functional group include an isocyanate group, a blocked isocyanate group, a methylol group, an alkylated methylol group, an epoxy group, a metal alkoxide group, a hydroxy group, an amino group, a carboxy group, a thiol group, a carboxylic anhydride group, and a carbon-carbon double bond group.

In addition, the undercoat layer may further contain an electron-transporting substance, metal oxide particles, metal particles, a conductive polymer, and the like for the purpose of improving electrical characteristics. Of those, an electron-transporting substance and metal oxide particles are preferably used.

Examples of the electron-transporting substance include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-containing compound. An electron-transporting substance having a polymerizable functional group may be used as the electron-transporting substance and copolymerized with the above-mentioned monomer having a polymerizable functional group to form the undercoat layer as a cured film.

Examples of the metal oxide particles include particles of indium tin oxide, tin oxide, indium oxide, titanium oxide, strontium titanate, zinc oxide, and aluminum oxide. Particles of silicon dioxide may also be used. Examples of the metal particles include particles of gold, silver, and aluminum.

The metal oxide particles to be incorporated into the undercoat layer may be subjected to surface treatment with a surface treatment agent such as a silane coupling agent before use.

A general method is used as a method of subjecting the metal oxide particles to the surface treatment. Examples thereof include a dry method and a wet method.

The dry method involves, while stirring the metal oxide particles in a mixer capable of high-speed stirring such as a Henschel mixer, adding an alcohol aqueous solution, an organic solvent solution, or an aqueous solution containing the surface treatment agent, and uniformly dispersing the mixture, followed by drying.

In addition, the wet method involves stirring the metal oxide particles and the surface treatment agent in a solvent, or dispersing the metal oxide particles and the surface treatment agent in a solvent with, for example, a sand mill through use of glass beads or the like. After the dispersion, the solvent is removed by filtration or evaporation under reduced pressure. After the removal of the solvent, it is preferred that baking be further performed at 100° C. or more.

The undercoat layer may further contain additives, and for example, known materials may be incorporated into the undercoat layer. Examples of the known materials include metal particles such as aluminum particles, conductive substance particles such as carbon black, a charge-transporting substance, a metal chelate compound, and an organometallic compound.

The undercoat layer may be formed by: preparing a coating liquid for an undercoat layer containing each of the above-mentioned materials and a solvent; forming a coat thereof on the support or the conductive layer; and drying and/or curing the coat.

Examples of the solvent to be used in the coating liquid for an undercoat layer include organic solvents, such as an alcohol, a sulfoxide, a ketone, an ether, an ester, an aliphatic halogenated hydrocarbon, and an aromatic compound. In the present disclosure, an alcohol-based solvent or a ketone-based solvent is preferably used.

Examples of a dispersion method for preparing the coating liquid for an undercoat layer include methods using a homogenizer, an ultrasonic disperser, a ball mill, a sand mill, a roll mill, a vibration mill, an attritor, and a liquid collision-type high-speed disperser.

The thickness of the undercoat layer is preferably 0.1 μm or more and 30 μm or less, particularly preferably 0.3 μm or more and 5 μm or less.

### <Charge-Generating Layer>

The charge-generating layer preferably contains the charge-generating substance and a resin.

Examples of the charge-generating substance include azo pigments, perylene pigments, polycyclic quinone pigments, indigo pigments, and phthalocyanine pigments. Of those, azo pigments and phthalocyanine pigments are preferred. Of the phthalocyanine pigments, a titanyl phthalocyanine pigment, an oxytitanium phthalocyanine pigment, a chlorogallium phthalocyanine pigment, and a hydroxygallium phthalocyanine pigment are preferred.

The content of the charge-generating substance in the charge-generating layer is preferably 40 mass % or more and 85 mass % or less, more preferably 60 mass % or more and 80 mass % or less with respect to the total mass of the charge-generating layer.

Examples of the resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin, and a polyvinyl chloride resin. Of those, a polyvinyl butyral resin is more preferred.

In addition, the charge-generating layer may further contain an additive, such as an antioxidant or a UV absorber. Specific examples thereof include a hindered phenol compound, a hindered amine compound, a sulfur compound, a phosphorus compound, and a benzophenone compound.

The charge-generating layer may be formed by: preparing a coating liquid for a charge-generating layer containing each of the above-mentioned materials and a solvent; forming a coat thereof on the undercoat layer; and drying the coat. Examples of the solvent to be used in the coating liquid include an alcohol-based solvent, a sulfoxide-based solvent, a ketone-based solvent, an ether-based solvent, an ester-based solvent, and an aromatic hydrocarbon-based solvent.

The thickness of the charge-generating layer is preferably 0.1 μm or more and 1 μm or less, more preferably 0.15 μm or more and 0.4 μm or less.

### <Charge-Transporting Layer>

The charge-transporting layer preferably contains the charge-transporting substance, a binding material, and silicon atom-containing particles.

As the charge-transporting substance of the present invention, at least a compound represented by the formula (A) is incorporated:

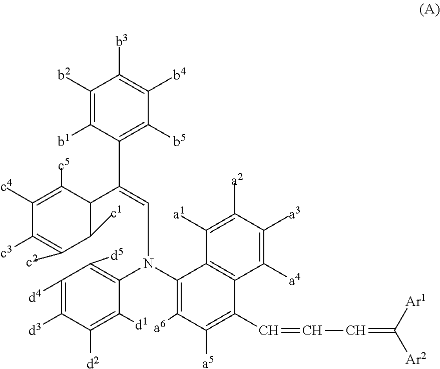

in the formula (A), a¹ to a⁶ each independently represent a hydrogen atom, a halogen atom, a substituted or unsubstituted alkyl group, a substituted or unsubstituted alkoxy group, a dialkylamino group, or a substituted or unsubstituted aryl group, or may be bonded to each other to form a ring structure, b¹ to b⁵, c¹ to c⁵, and d¹ to d⁵ each independently represent a hydrogen atom, a halogen atom, a substituted or unsubstituted alkyl group, a substituted or unsubstituted alkoxy group, a dialkylamino group, a substituted or unsubstituted aryl group, a substituted or unsubstituted aryloxy group, or a substituted or unsubstituted arylthio group, or may be bonded to each other to form a ring structure, and Ar¹ and Ar² each independently represent a hydrogen atom, a substituted or unsubstituted alkyl group, a substituted or unsubstituted aryl group, a substituted or unsubstituted aralkyl group, or a substituted or unsubstituted heterocyclic group, or may be bonded to each other to form a ring structure, provided that Ar¹ and Ar² are prevented from both representing hydrogen atoms.

Examples of the aryl group that may have a substituent, the group being represented by each of Ar¹ and Ar², include a phenyl group, an o-tolyl group, a m-tolyl group, a p-tolyl group, a 4-isopropylphenyl group, a 3,4-dimethylphenyl group, a 2-fluorophenyl group, a 4-chlorophenyl group, a 4-(2-fluoroethyl)phenyl group, a 4-methoxyphenyl group, a 2,4-dimethoxyphenyl group, a 2-methyl-4-methoxyphenyl group, a 2,5-dimethyl-4-methoxyphenyl group, a 4-biphenylyl group, a p-terphenyl group, a 4-dimethylaminophenyl group, a 4-trifluoromethylphenyl group, a 1-naphthyl group, a 2-naphthyl group, a 2-methyl-1-naphthyl group, a 4-methyl-1-naphthyl group, a 5-methyl-1-naphthyl group, a 4-methoxy-1-naphthyl group, a 6-methoxy-2-naphthyl group, a 2-methyl-4-methoxy-1-naphthyl group, a 9-anthryl group, a 1-pyrenyl group, a 4-(4-methyl-phenoxy)phenyl group, a 4-(phenylthio)phenyl group, a 2,5-dimethyl-4-(phenylthio)phenyl group, a p-(phenylthio)phenyl group, and a p-styrylphenyl group.

Examples of the alkyl group that may have a substituent, the group being represented by each of Ar¹ and Ar², include a methyl group, an ethyl group, a n-propyl group, an isopropyl group, a n-butyl group, an isobutyl group, a trifluoromethyl group, a fluoromethyl group, and a 1-methoxyethyl group.

Examples of the monovalent heterocyclic group that may have a substituent, the group being represented by each of Ar¹ and Ar², include an 8-chromanyl group, a furyl group, a thienyl group, a 5-methyl-2-furyl group, a 5-methyl-2-thienyl group, a 5-methyl-N-ethylcarbazol-4-yl group, a thiazolyl group, a benzofuryl group, a benzothiophenyl group, an N-methylindolyl group, a benzothiazolyl group, and a benzoxazolyl group.

Ar¹ and Ar² may be bonded to each other through an atom or an atomic group to form a ring structure. Specific examples of the atom for bonding include an oxygen atom and a sulfur atom. Specific examples of the atomic group for bonding include: divalent atomic groups such as a nitrogen atom with an alkyl group; and divalent groups, including alkylene groups, such as methylene, ethylene, and methylmethylene, unsaturated alkylene groups, such as vinylene and propenylene, alkylene groups each containing a heteroatom such as oxymethylene (chemical formula: —O—CH₂—), and unsaturated alkylene groups each containing a heteroatom such as thiovinylene (chemical formula: —S—CH═CH—).

Examples of the alkyl group that may have a substituent, the group being represented by each of a¹ to a⁶, include a methyl group, an ethyl group, a n-propyl group, an isopropyl group, a n-butyl group, an isobutyl group, a trifluoromethyl group, a fluoromethyl group, and a 1-methoxyethyl group.

Examples of the alkoxy group that may have a substituent, the group being represented by each of a¹ to a⁶, include a methoxy group, an ethoxy group, a n-propoxy group, and an isopropoxy group.

Examples of the dialkylamino group that may have a substituent, the group being represented by each of a¹ to a⁶, include a dimethylamino group, a diethylamino group, and a diisopropylamino group.

Examples of the aryl group that may have a substituent, the group being represented by each of a¹ to a⁶, include a phenyl group, an o-tolyl group, a m-tolyl group, a p-tolyl group, and a 4-methoxyphenyl group.

Examples of the halogen atom represented by each of a¹ to a⁶ include a fluorine atom, a chlorine atom, a bromine atom, and an iodine atom.

Examples of the alkyl group that may have a substituent, the group being represented by each of b¹ to b⁵, c¹ to c⁵, and d¹ to d⁵, include a methyl group, an ethyl group, a n-propyl group, an isopropyl group, a n-butyl group, an isobutyl group, a trifluoromethyl group, a fluoromethyl group, and a 1-methoxyethyl group.

Examples of the alkoxy group that may have a substituent, the group being represented by each of b¹ to b⁵, c¹ to c⁵, and d¹ to d⁵, include a methoxy group, an ethoxy group, a n-propoxy group, and an isopropoxy group.

Examples of the dialkylamino group that may have a substituent, the group being represented by each of b¹ to b⁵, c¹ to c⁵, and d¹ to d⁵, include a dimethylamino group, a diethylamino group, and a diisopropylamino group.

Examples of the aryl group that may have a substituent, the group being represented by each of b¹ to b⁵, c¹ to c⁵, and d¹ to d⁵, include the same groups as those represented by Ar¹ and Ar².

An example of the aryloxy group that may have a substituent, the group being represented by each of b¹ to b⁵, c¹ to c⁵, and d¹ to d⁵, is a 4-methylphenoxy group.

An example of the arylthio group that may have a substituent, the group being represented by each of b¹ to b⁵, c¹ to c⁵, and d¹ to d⁵, is a phenylthio group.

Examples of the halogen atom represented by each of b¹ to b⁵, c¹ to c⁵, and d¹ to d⁵ include a fluorine atom, a chlorine atom, a bromine atom, and an iodine atom.

The compound represented by the formula (A) is a compound that is generally called “enamine-based compound.”

Specific examples of the compound represented by the formula (A) of the present invention are shown in Table 1 below.

TABLE 1

| | |
|---|---|
| Exemplary compound 1 | 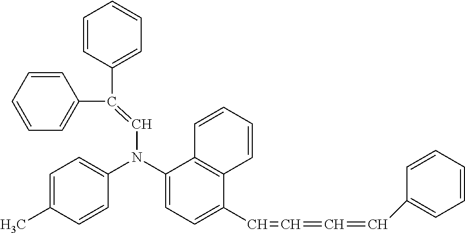 [SMILES: Cc1ccc(N(C=C(c2ccccc2)c2ccccc2)c2ccc(C=C=C=Cc3ccccc3)c3ccccc23)cc1] |
| Exemplary compound 2 | 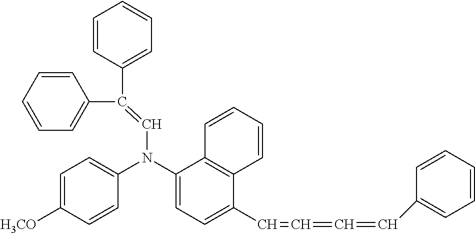 [SMILES: COc1ccc(N(C=C(c2ccccc2)c2ccccc2)c2ccc(C=C=C=Cc3ccccc3)c3ccccc23)cc1] |
| Exemplary compound 3 | 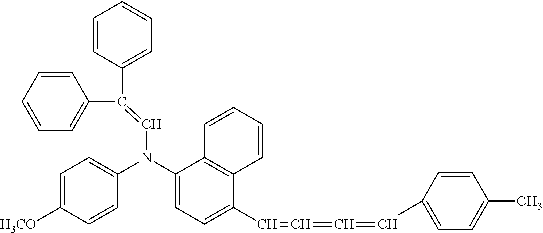 [SMILES: COc1ccc(N(C=C(c2ccccc2)c2ccccc2)c2ccc(C=C=C=Cc3ccc(C)cc3)c3ccccc23)cc1] |
| Exemplary compound 4 | 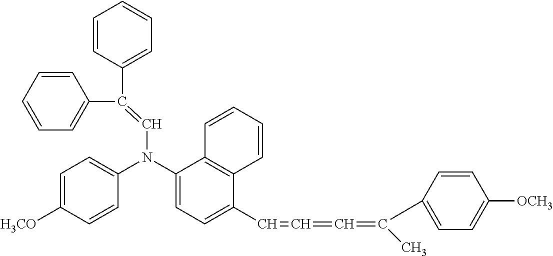 [SMILES: COc1ccc(C(C)=C=C=Cc2ccc(N(C=C(c3ccccc3)c3ccccc3)c3ccc(OC)cc3)c3ccccc23)cc1] |
| Exemplary compound 5 | 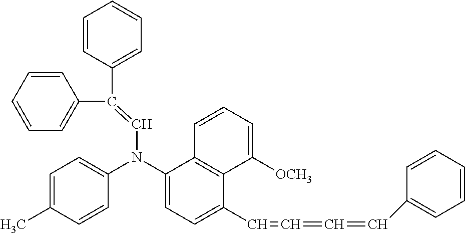 [SMILES: COc1cccc2c(N(C=C(c3ccccc3)c3ccccc3)c3ccc(C)cc3)ccc(C=C=C=Cc3ccccc3)c12] |

In the charge-transporting layer, any other charge-transporting substance, such as a polycyclic aromatic compound, a heterocyclic compound, a hydrazone compound, a styryl compound, a triarylamine compound, or a resin having a group derived from each of those substances, may be used in combination with the compound represented by the formula (A).

The content of the charge-transporting substance in the charge-transporting layer is preferably 25 mass % or more and 70 mass % or less, more preferably 30 mass % or more and 55 mass % or less with respect to the total mass of the charge-transporting layer.

A thermoplastic resin (hereinafter also referred to as “resin”) is used as the binding material.

Examples of the thermoplastic resin include a polyester resin, a polycarbonate resin, an acrylic resin, and a polystyrene resin. Of those, a polycarbonate resin and a polyester resin are preferred.

A content ratio (mass ratio) between the charge-transporting substance and the resin is preferably from 3:10 to 20:10, more preferably from 5:10 to 12:10.

The silicon atom-containing particles are added for the purpose of suppressing the change in sensitivity of the enamine-based compound caused by moisture in the present invention described above.

The silicon atom-containing particles in the present invention are silica particles or silicone resin particles. Of those, silica particles are preferred.

Commercially available silica particles that may be used in the present disclosure are, for example, silica particles available under the product names “AEROSIL (trademark) 130”, “AEROSIL R972”, “AEROSIL R974”, “AEROSIL NY50”, and “AEROSIL RX50” from Nippon Aerosil Co., Ltd., silica particles available under the product names “TS-610”, “TS-612”, “TS-620”, and “TS-630” from Cabot Japan K.K., silica particles available under the product name “X-24-9163A” from Shin-Etsu Chemical Co., Ltd., silica particles available under the product names “SO-E1”, “SO-E2”, “SE100-GDT”, and “SE100-SPT” from Admatechs Company Limited, and silica particles available under the product name “SiliNax” from Nittetsu Mining Co., Ltd.

Commercially available silicone resin particles that may be used in the present disclosure are, for example, silicone resin particles available under the product names “X-52-854”, “X-52-1621”, and “KMP-590” from Shin-Etsu Chemical Co., Ltd., and silicone resin particles available under the product names “MSP-N050” and “MSP-N080” from Nikko Rica Corporation.

The content of the silicon atom-containing particles in the charge-transporting layer is preferably 1 mass % or more and 20 mass % or less with respect to the total mass of the charge-transporting layer. When the content is 1 mass % or less, the effects of the present invention are not easily obtained. When the content is more than 20 mass %, a light potential in an exposed portion is increased due to an increase in residual charge at the time of repeated use.

A mass ratio between the compound represented by the formula (A) and the silicon atom-containing particles in the surface layer is preferably from 3:1 to 20:1.

The number-average primary particle diameter of the silicon atom-containing particles to be incorporated into the charge-transporting layer is determined from the cross-section of the charge-transporting layer. Specifically, 50 silicon atom-containing particles in the cross-section of the surface layer are observed, and an image is obtained. Each longest diameter is determined by subjecting the image to ellipse fitting. An average of the 10 longest diameters from longest among the determined longest diameters is defined as the average primary particle diameter of the silicon atom-containing particles.

The number-average primary particle diameter of the silicon atom-containing particles is preferably 1 nm or more and 500 nm or less, more preferably 5 nm or more and 300 nm or less.

In addition, the charge-transporting layer may contain various additives, such as an antioxidant, a UV absorber, a plasticizer, and a leveling agent. Specific examples thereof include a hindered phenol compound, a hindered amine compound, a sulfur compound, a phosphorus compound, a benzophenone compound, a siloxane-modified resin, a silicone oil, polystyrene resin particles, polyethylene resin particles, and boron nitride particles.

The charge-transporting layer may be formed by: preparing a coating liquid for a charge-transporting layer containing each of the above-mentioned materials and a solvent; forming a coat thereof on the charge-generating layer; and drying the coat. Examples of the solvent to be used in the coating liquid include an alcohol-based solvent, a ketone-based solvent, an ether-based solvent, an ester-based solvent, and an aromatic hydrocarbon-based solvent. Of those solvents, an ether-based solvent or an aromatic hydrocarbon-based solvent is preferred.

The thickness of the charge-transporting layer is preferably 5 μm or more and 50 μm or less, more preferably 8 μm or more and 40 μm or less, particularly preferably 15 μm or more and 35 μm or less.

### [Toner and Developer]

The toner to be used in the electrophotographic apparatus of the present disclosure is a toner including toner particles each containing a polyester resin having a polyethylene terephthalate segment.

The toner according to the present disclosure is described below.

### <Polyester Resin Having Polyethylene Terephthalate Segment>

Examples of a component for forming the polyester resin having the polyethylene terephthalate segment include a polyethylene terephthalate segment, dihydric or higher alcohol monomer components, and acid monomer components, such as divalent or higher carboxylic acids, divalent or higher carboxylic anhydrides, and divalent or higher carboxylic acid esters.

### <Polyethylene Terephthalate Segment>

The polyethylene terephthalate segment of the present disclosure has a structure in which (C₁₀H₈O₄), which is a structural unit of polyethylene terephthalate, is repeated.

As the polyethylene terephthalate segment of the present disclosure, a polyethylene terephthalate segment that is produced by a condensation reaction or a transesterification reaction between ethylene glycol and terephthalic acid, dimethyl terephthalate, or the like in accordance with an ordinary method may be used. In addition, a recovered polyethylene terephthalate resin may also be used.

Further, it is more preferred that such a toner as described below be used because low-temperature fixability and scratch resistance can be improved.

The toner to be preferably used in the present disclosure is characterized by the following: the toner is a toner including toner particles each containing a binder resin; the binder resin contains an amorphous resin A and a crystalline polyester C; the amorphous resin A is the polyester resin and has, as structures for forming a polyester backbone,
(i) the polyethylene terephthalate segment, and
(ii) at least one structure selected from the group consisting of units represented by the following formulae (1) to (4):

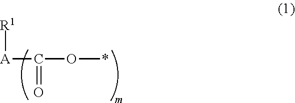

where R¹ represents an alkyl group having 6 to 16 carbon atoms or an alkenyl group having 6 to 16 carbon atoms, A represents a hydrocarbon group, “*” represents a bonding site in the polyester backbone, and “m” represents an integer of 2 or more;

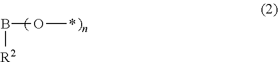

where R² represents an alkyl group having 6 to 16 carbon atoms or an alkenyl group having 6 to 16 carbon atoms, B represents a hydrocarbon group, “*” represents a bonding site in the polyester backbone, and “n” represents an integer of 2 or more;

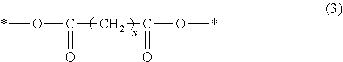

where “*” represents a bonding site in the polyester backbone, and “x” represents an integer of from 6 to 16;

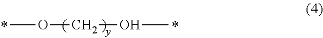

where “*” represents a bonding site in the polyester backbone, and “y” represents an integer of from 6 to 16;
when an SP value of the amorphous resin A is represented by SP_{A} (cal/cm³)^{0.5}, and an SP value of the crystalline polyester C is represented by SP_{C} (cal/cm³)^{0.5}, the SP_{A} and the SP_{C} satisfy the following formula (C):

$$1. 00 \leq {SP}_{A} - {SP}_{C} \leq 1.35 ; \qquad ( C )$$

the toner contains a phosphorus element derived from a phosphorus compound; and, when a content of the phosphorus element in the toner based on a mass of the toner is represented by W_{P} (ppm), the W_{P} satisfies the following formula (D):

$$5 \leq {W}_{P} \leq 500 . \qquad ( D )$$

A case in which the W_{P} satisfies the following formula (E) is more preferred:

$$20 \leq {W}_{P} \leq 500 . \qquad ( E )$$

The reasons for the improvement of the low-temperature fixability and the scratch resistance are described below.

Investigations made by the inventors have found that the toner having such characteristics as described below improves scratch resistance while exhibiting satisfactory low-temperature fixability.
(i) A three-dimensional structure can be flexibly deformed in a direction in which external force is applied.
(ii) When the external force is removed, an original three-dimensional structure can be recovered.

Such toner can be achieved by the above-mentioned configuration.

The amorphous resin A has at least one structure selected from the group consisting of the units represented by the formulae (1) to (4), and the SP values of the amorphous resin A and the crystalline polyester C are controlled. As a result, the amorphous resin A has affinity for the crystalline polyester C. Thus, in a fixed image, the amorphous resin A is influenced by the crystalline polyester C to become flexible. In addition, this structure disperses the applied external force, and hence the three-dimensional structure can be flexibly deformed in the direction in which the external force is applied without a molecular chain being broken. In addition, the amorphous resin A contains the polyethylene terephthalate segment and hence has a repeating structure of a condensate of terephthalic acid and ethylene glycol in the polyester backbone. In the structure derived from the ethylene glycol of the polyethylene terephthalate segment, both terminals of the ethylene glycol are subjected to an esterification reaction, and hence the structure has ester groups at a significantly close molecular distance corresponding to two carbon atoms. Thus, the amorphous resin A has ester groups localized in the resin. In addition, the phosphorus compound in which three unshared electron pairs in the outermost shell are caused to react also has bonding points at a significantly close molecular distance. As a result, the amorphous resin A can interact with the ester groups localized in the amorphous resin A around phosphorus elements of the phosphorus compound, and thus can form a three-dimensional crosslinked structure. By virtue of the presence of this structure, when the applied external force is removed, the deformed state can be returned to the original three-dimensional structure. As described above, it is conceived that the configuration of the present disclosure enables excellent low-temperature fixability and scratch resistance to be obtained.

The amorphous resin A in the present disclosure has at least one structure selected from the group consisting of the units represented by the formulae (1) to (4) as the structure for forming the polyester backbone. The structure of the long-chain hydrocarbon group, such as an alkyl group or an alkenyl group, in each of the units represented by the formulae (1) to (4) becomes a structure having relatively low polarity as compared to the above-mentioned structure derived from the ethylene glycol of the polyethylene terephthalate segment. As a result, the structure of the long-chain hydrocarbon group, such as an alkyl group or an alkenyl group, in each of the units represented by the formulae (1) to (4) becomes flexible when the affinity for the crystalline polyester C is increased. In addition, this structure disperses the applied external force, and hence the three-dimensional structure can be flexibly deformed in the direction in which the external force is applied without a molecular chain being broken. As a result, the improvement of elastic deformation is achieved to provide excellent scratch resistance. In addition, the SP_{A} (cal/cm³)^{0.5} of the amorphous resin A and the SP_{C} (cal/cm³)^{0.5} of the crystalline polyester C in the present disclosure satisfy the formula (C). When SP_{A}-SP_{C} satisfies the formula (C), the amorphous resin A and the crystalline polyester C easily become compatible, and hence the crystalline polyester C can smoothly work on the structure of the amorphous resin A having the long-chain hydrocarbon group, such as an alkyl group or an alkenyl group. As a result, this structure becomes flexible when the affinity for the crystalline polyester C is increased. In addition, this structure disperses the applied external force, and hence the three-dimensional structure can be flexibly deformed in the direction in which the external force is applied without a molecular chain being broken. As a result, the improvement of an elastic deformation characteristic is achieved to provide excellent scratch resistance.

Further, the toner of the present disclosure contains phosphorus elements derived from the phosphorus compound, and the W_{P} (ppm) satisfies the formula (D). When the content of the phosphorus elements in the toner satisfies the formula (D), this case indicates that the phosphorus elements are present in an amount sufficient for an interaction with the ester groups localized in the amorphous resin A around the phosphorus elements to form a three-dimensional crosslinked structure. That is, the above-mentioned content corresponds to the minimum amount of the phosphorus elements in which the applied external force is dispersed, and hence the three-dimensional structure can be flexibly changed in the direction in which the external force is applied without breakage of the molecular chain, and the maximum amount of the phosphorus elements in which a certain degree of plastic deformation capable of ensuring low-temperature fixability can be ensured.

### <Amorphous Resin A>

The amorphous resin A is a polyester resin and has the following (i) and (ii) as structures for forming a polyester backbone:
(i) a polyethylene terephthalate segment; and
(ii) at least one structure selected from the group consisting of the units represented by the formulae (1) to (4).

The polyethylene terephthalate structure to be used in the amorphous resin A is obtained by subjecting ethylene glycol and terephthalic acid to polycondensation.

In addition, the synthesis of the polyester resin may be performed in an inert gas atmosphere, preferably in the presence of an esterification catalyst, and further as required, in the presence of an esterification promoter, a polymerization inhibitor, and the like, preferably at a temperature of 180° C. or more and 250° C. or less.

Examples of the esterification catalyst include a tin compound, such as dibutyltin oxide or tin(II) 2-ethylhexanoate, and a titanium compound such as titanium diisopropylate bistriethanolaminate. Of those, a tin compound such as tin(II) 2-ethylhexanoate is preferred. The usage amount of the esterification catalyst is preferably 0.01 part by mass or more, more preferably 0.1 part by mass or more, and preferably 1.5 parts by mass or less, more preferably 1.0 part by mass or less with respect to 100 parts by mass of the raw material monomers (an alcohol component, a carboxylic acid component, and PET). An example of the esterification promoter is gallic acid. The usage amount of the esterification promoter is preferably 0.001 part by mass or more, more preferably 0.01 part by mass or more and preferably 0.5 part by mass or less, more preferably 0.1 part by mass or less with respect to 100 parts by mass of the raw material monomers. An example of the polymerization inhibitor is tert-butyl catechol. The usage amount of the polymerization inhibitor is preferably 0.001 part by mass or more, more preferably 0.01 part by mass or more and preferably 0.5 part by mass or less, more preferably 0.1 part by mass or less with respect to 100 parts by mass of the raw material monomers.

In addition, in the synthesis of the polyester resin, the polyethylene terephthalate may be allowed to be present from the start of the polycondensation reaction, or may be added to the reaction system during the polycondensation reaction. In order for the polyethylene terephthalate segment to be incorporated into the main backbone of the polyester in a block form to a certain extent, the timing of the addition of the polyethylene terephthalate is preferably in a stage in which the reaction rate of the alcohol component and the carboxylic acid component is 10% or less, more preferably in a stage in which the reaction rate is 5% or less. Herein, the reaction rate refers to the value of generated reaction water amount (mol)/theoretical generated water amount (mol)×100.

In addition, spent polyethylene terephthalate (so-called regenerated PET) may be used as the polyethylene terephthalate segment to be incorporated into the amorphous resin A. It is preferred that the polyethylene terephthalate be reused from the viewpoint of the environment.

The spent PET is recovered. The recovered PET is washed and sorted so as to be prevented from being mixed with other materials and dust. After a label and the like are removed, the resultant is pulverized into flakes or the like. The pulverized product may be used as it is, or the pulverized product, which is kneaded and coarsely pulverized, may also be used. When chemical substances adsorbed to the surface of a PET bottle cannot be sufficiently removed by ordinary washing, alkali washing may be performed. When part of the pulverized product is hydrolyzed by the alkali washing, it is preferred that the washed pulverized product, which is melted and pelletized, be subjected to solid phase polymerization in order to restore the reduced polymerization degree. A solid-phase polymerization step may be performed by subjecting the washed flakes or the flakes, which are melted and extruded into pellets, to continuous solid-phase polymerization in an inert gas, such as a nitrogen gas or a noble gas, at a temperature of from 180° C. to 245° C., preferably from 200° C. to 240° C. In addition, the washed pulverized product, which is decomposed to a monomer unit by depolymerization and resynthesized, may also be used. In addition, the regenerated PET is not limited to the above-mentioned spent PET, and fiber scraps or pellets of off-spec PET discharged from factories may also be used.

In addition, in order to incorporate at least one unit selected from the group consisting of the units represented by the formulae (1) to (4) into the amorphous resin A, the following monomers may be used. Examples thereof include 1,6-hexanediol, 1,7-heptanediol, 1,8-octanediol, 1,9-nonanediol, 1,10-decanediol, 1,11-undecanediol, 1,12-dodecanediol, suberic acid, azelaic acid, sebacic acid, undecanedioic acid, dodecanedioic acid, hexadecanedioic acid, octadecanedioic acid, dodecenylsuccinic acid, n-octylsuccinic acid, isododecenylsuccinic acid, dodecylsuccinic acid, isooctenylsuccinic acid, and hexadecylsuccinic acid.

Of the units represented by the formulae (1) to (4), the units represented by the formula (1) and the formula (2) are preferred. The alkyl group or alkenyl group having 6 to 16 carbon atoms is branched from the main chain of the polyester backbone. Thus, the affinity for a release agent is enhanced, and the dispersibility of the release agent is further enhanced.

In addition, as components for obtaining the amorphous resin A, other polyhydric alcohols (dihydric or higher alcohols), polyvalent carboxylic acids (divalent or higher carboxylic acids), and acid anhydrides or lower alkyl esters thereof may be used in addition to the above-mentioned structures and monomers.

The following polyhydric alcohol monomers may each be used as a polyhydric alcohol monomer. As a dihydric alcohol component, there are given, for example: ethylene glycol, propylene glycol, 1,3-butanediol, 1,4-butanediol, 2,3-butanediol, diethylene glycol, triethylene glycol, neopentyl glycol, 2-ethyl-1,3-hexanediol, hydrogenated bisphenol A, and a bisphenol represented by the formula (X) and derivatives thereof:

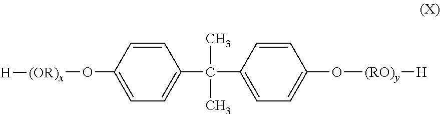

where R represents an ethylene or propylene group, “x” and “y” each represent an integer of 0 or more, and the average of x+y is 0 or more and 10 or less;
and diols each represented by the formula (Y):

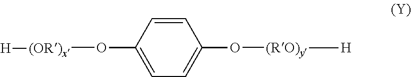

where R′ represents —CH₂CH₂—, —CH₂CH(CH₃)—, or —CH₂C(CH₃)₂—, x′ and y′ each represent an integer of 0 or more, and the average of x′+y′ is from 0 to 10.

As a trihydric or higher alcohol component, there are given, for example, sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene. Of those, glycerol, trimethylolpropane, and pentaerythritol are preferably used.

Those dihydric alcohols and trihydric or higher alcohols may be used alone or in combination thereof.

As a divalent carboxylic acid component, there are given, for example, maleic acid, fumaric acid, citraconic acid, itaconic acid, glutaconic acid, phthalic acid, isophthalic acid, terephthalic acid, succinic acid, azelaic acid, malonic acid, anhydrides of those acids, and lower alkyl esters thereof. Of those, maleic acid, fumaric acid, and terephthalic acid are preferably used.

As a trivalent or higher carboxylic acid, an acid anhydride thereof, or a lower alkyl ester thereof, there are given, for example, 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, EMPOL trimer acid, and acid anhydrides thereof or lower alkyl esters thereof. Of those, 1,2,4-benzenetricarboxylic acid, that is, trimellitic acid or a derivative thereof is particularly preferably used because trimellitic acid or the derivative thereof is available at low cost and its reaction can be easily controlled. Those divalent carboxylic acids and trivalent or higher carboxylic acids may be used alone or in combination thereof.

A method of producing the amorphous resin A is not particularly limited, and a known method may be used. For example, the polyester resin is produced by simultaneously loading the above-mentioned alcohol monomer and carboxylic acid monomer and polymerizing the mixture through an esterification reaction or a transesterification reaction and a condensation reaction. In addition, a polymerization temperature is not particularly limited, but preferably falls within the range of 180° C. or more and 290° C. or less. In the polymerization of a polyester unit, a polymerization catalyst, such as a titanium-based catalyst, a tin-based catalyst, zinc acetate, antimony trioxide, or germanium dioxide, may be used. In particular, the amorphous resin A is more preferably a polyester resin polymerized through use of a tin-based catalyst.

The amorphous resin A may be a polyester resin having a vinyl-based resin portion. A method of obtaining a polyester having a vinyl-based resin bonded thereto is preferably a method involving using a monomer component that may react with both the vinyl-based resin and the polyester unit. Such monomer is preferably a monomer having an unsaturated double bond and a carboxy group or a hydroxy group. Examples thereof include unsaturated dicarboxylic acids, such as phthalic acid, maleic acid, citraconic acid, and itaconic acid, or anhydrides thereof, and acrylic acid or methacrylic acid esters.

In addition, the peak molecular weight of the amorphous resin A is preferably 3,500 or more and 20,000 or less from the viewpoint of, for example, low-temperature fixability. The glass transition temperature of the resin is preferably from 40° C. to 70° C.

In addition, as an amorphous resin, various resins that have hitherto been known as binder resins may each be used in combination with the amorphous resin A. Examples of such resin include a phenol resin, a natural resin-modified phenol resin, a natural resin-modified maleic resin, an acrylic resin, a methacrylic resin, a polyvinyl acetate resin, a silicone resin, a polyester resin, a polyurethane resin, a polyamide resin, a furan resin, an epoxy resin, a xylene resin, a polyvinyl butyral resin, a terpene resin, a coumarone-indene resin, and a petroleum-based resin.

### <Crystalline Polyester C>

A polyhydric alcohol (dihydric or trihydric or higher alcohol), and a polyvalent carboxylic acid (divalent or trivalent or higher carboxylic acid), an acid anhydride thereof, or a lower alkyl ester thereof are used as monomers to be used for the polyester unit of the crystalline polyester C to be used in the toner of the present disclosure.

The following polyhydric alcohol monomers may each be used as a polyhydric alcohol monomer to be used for the polyester unit of the crystalline polyester C.

The polyhydric alcohol monomer is not particularly limited, but is preferably a chain (more preferably straight-chain) aliphatic diol. Examples thereof include ethylene glycol, diethylene glycol, triethylene glycol, 1,2-propylene glycol, 1,3-propylene glycol, dipropylene glycol, 1,6-hexanediol, 1,4-butanediol, 1,4-butadiene glycol, trimethylene glycol, tetramethylene glycol, pentamethylene glycol, hexamethylene glycol, octamethylene glycol, nonamethylene glycol, decamethylene glycol, and neopentyl glycol. Of those, straight-chain aliphatic α,ω-diols, such as ethylene glycol, diethylene glycol, 1,4-butanediol, and 1,6-hexanediol, are particularly preferred examples.

In the present disclosure, a polyhydric alcohol monomer except the above-mentioned polyhydric alcohols may also be used. Examples of a dihydric alcohol monomer out of the polyhydric alcohol monomers include: an aromatic alcohol, such as polyoxyethylenated bisphenol A or polyoxypropylenated bisphenol A; and 1,4-cyclohexanedimethanol. In addition, examples of a trihydric or higher polyhydric alcohol monomer out of the polyhydric alcohol monomers include: an aromatic alcohol such as 1,3,5-trihydroxymethylbenzene; and an aliphatic alcohol, such as pentaerythritol, dipentaerythritol, tripentaerythritol, 1,2,4-butanetriol, 1,2,5-pentanetriol, glycerin, 2-methylpropanetriol, 2-methyl-1,2,4-butanetriol, trimethylolethane, ortrimethylolpropane.

The following polyvalent carboxylic acid monomers may each be used as a polyvalent carboxylic acid monomer to be used for the polyester unit of the crystalline polyester C.

The polyvalent carboxylic acid monomer is not particularly limited, but is preferably a chain (more preferably straight-chain) aliphatic dicarboxylic acid. Specific examples thereof include: oxalic acid, malonic acid, succinic acid, glutaric acid, adipic acid, pimelic acid, suberic acid, glutaconic acid, azelaic acid, sebacic acid, nonanedicarboxylic acid, decanedicarboxylic acid, undecanedicarboxylic acid, dodecanedicarboxylic acid, maleic acid, fumaric acid, mesaconic acid, citraconic acid, and itaconic acid; and products obtained by hydrolyzing acid anhydrides or lower alkyl esters thereof.

In the present disclosure, a polyvalent carboxylic acid except the above-mentioned polyvalent carboxylic acid monomers may also be used. Examples of a divalent carboxylic acid out of the other polyvalent carboxylic acid monomers include: an aromatic carboxylic acid, such as isophthalic acid or terephthalic acid; an aliphatic carboxylic acid, such as n-dodecylsuccinic acid or n-dodecenylsuccinic acid; an alicyclic carboxylic acid such as cyclohexanedicarboxylic acid; and acid anhydrides or lower alkyl esters thereof. In addition, examples of a trivalent or higher polyvalent carboxylic acid out of the other carboxylic acid monomers include: an aromatic carboxylic acid, such as 1,2,4-benzenetricarboxylic acid (trimellitic acid), 2,5,7-naphthalenetricarboxylic acid, 1,2,4-naphthalenetricarboxylic acid, or pyromellitic acid; an aliphatic carboxylic acid, such as 1,2,4-butanetricarboxylic acid, 1,2,5-hexanetricarboxylic acid, or 1,3-dicarboxy-2-methyl-2-methylenecarboxypropane; and derivatives, such as acid anhydrides or lower alkyl esters, thereof.

In addition, the crystalline polyester C is preferably a modified crystalline polyester having a structure in which a hydroxy group at a main chain terminal is terminally modified with an aliphatic monocarboxylic acid having 16 to 31 carbon atoms, or a modified crystalline polyester having a structure in which a carboxy group at a main chain terminal is terminally modified with an aliphatic monoalcohol having 15 to 30 carbon atoms.

Examples of the aliphatic monocarboxylic acid monomer having 16 to 31 carbon atoms include palmitic acid (hexadecanoic acid), margaric acid (heptadecanoic acid), stearic acid (octadecanoic acid), nonadecylic acid, arachidic acid (icosanoic acid), henicosanoic acid, docosanoic acid, tetracosanoic acid, hexacosanoic acid, octacosanoic acid, and triacontanoic acid.

Examples of the aliphatic monoalcohol having 15 to 30 carbon atoms include cetyl alcohol, palmityl alcohol (hexadecanol), margaryl alcohol (heptadecanol), stearyl alcohol (octadecanol), nonadecanol, arachidyl alcohol (icosanol), heneicosanol, behenyl alcohol, lignoceryl alcohol, ceryl alcohol, 1-heptacosanol, montanyl alcohol, 1-nonacosanol, and myricyl alcohol.

The crystalline polyester C may be produced in accordance with an ordinary polyester synthesis method. For example, the crystalline polyester may be obtained by: subjecting the carboxylic acid monomer and alcohol monomer described above to an esterification reaction or a transesterification reaction; and then subjecting the resultant to a polycondensation reaction in accordance with an ordinary method under reduced pressure or while introducing a nitrogen gas. After that, a desired crystalline polyester C is obtained by further adding the above-mentioned aliphatic compound and performing an esterification reaction.

The esterification or transesterification reaction may be performed with a general esterification catalyst or transesterification catalyst, such as sulfuric acid, titanium butoxide, dibutyltin oxide, manganese acetate, or magnesium acetate, as required.

In addition, the polycondensation reaction may be performed with a known catalyst, for example, an ordinary polymerization catalyst, such as titanium butoxide, dibutyltin oxide, tin acetate, zinc acetate, tin disulfide, antimony trioxide, or germanium dioxide. A polymerization temperature and a catalyst amount are not particularly limited, and may be appropriately determined.

In the esterification or transesterification reaction, or the polycondensation reaction, the following method may be used: all the monomers are collectively loaded in order to improve the strength of the crystalline polyester C to be obtained. In addition, for example, the following method may be used: the divalent monomers are caused to react with each other first, and then a monomer that is trivalent or more is added to, and caused to react with, the resultant, in order to reduce the amount of a low-molecular weight component.

The melting point of the crystalline polyester C is preferably from 70° C. to 110° C., more preferably from 80° C. to 100° C. from the viewpoint of low-temperature fixability. In the toner of the present disclosure, it is preferred that the crystalline polyester C be used in an amount of from 3 parts by mass or more and 20 parts by mass or less with respect to 100 parts by mass of the amorphous resin from the viewpoints of low-temperature fixability, scratch resistance, and a chargeability maintaining property under a high-temperature and high-humidity environment.

### <Phosphorus Compound>

Examples of the phosphorus compound to be used for the toner of the present disclosure include trisodium phosphate, trimethyl phosphate, triethyl phosphate, tri-2-ethylhexyl phosphate, tris(isopropylphenyl) phosphate, triphenyl phosphate, tributyl phosphate, trimethyl phosphite, tributyl phosphite, and triphenyl phosphite. Of those, a trivalent phosphorus compound that easily forms a three-dimensional crosslink is preferred.

The content W_{P} of the phosphorus element is as described above. Further, in order to form a three-dimensional crosslinked structure, spent polyethylene terephthalate (so-called regenerated PET) is preferably used because the block of polyethylene terephthalate is easily formed, and hence the ester groups at a close molecular distance can be more easily assembled to form a strong three-dimensional crosslinked structure. This structure can be returned to an original three-dimensional structure when the applied external force is removed.

### <Release Agent>

The toner particles may each contain a wax as a release agent. Examples of the wax include a polyethylene wax, a polypropylene wax, a polypropylene copolymer wax, a microcrystalline wax, a paraffin wax, a Fischer-Tropsch wax, a carnauba wax, a rice wax, a candelilla wax, and a montan wax.

### <Colorant>

The toner may contain a colorant. Examples of the colorant include known organic pigments, oil-based dyes, and magnetic materials. Examples of the colorant include carbon black, Phthalocyanine Blue, Permanent Brown FG, Brilliant Fast Scarlet, Pigment Red 122, Pigment Green B, Rhodamine-B base, Solvent Red 49, Solvent Red 146, Solvent Blue 35, quinacridone, Carmine 6B, isoindoline, Disazo Yellow, Benzidine Yellow, a monoazo-based dye or pigment, and a disazo-based dye or pigment.

### <Charge Control Agent>

The toner particles may each contain a charge control agent as required. When the charge control agent is blended, charge characteristics can be stabilized, and hence the optimum triboelectric charge quantity can be controlled in accordance with a developing system. Known charge control agents may each be used as the charge control agent, but in particular, a metal compound of an aromatic carboxylic acid that is colorless, can charge a toner at a high speed, and can stably hold a constant charge quantity is preferred.

As a negative charge control agent, there are given, for example: a salicylic acid metal compound; a naphthoic acid metal compound; a dicarboxylic acid metal compound; a polymer-type compound having a sulfonic acid or a carboxylic acid in a side chain thereof, a polymer-type compound having a sulfonate or a sulfonic acid esterified product in a side chain thereof, a polymer-type compound having a carboxylate or a carboxylic acid esterified product in a side chain thereof; a boron compound; a urea compound; a silicon compound; and a calixarene.

### <Inorganic Fine Particles>

The toner may include inorganic fine particles as required.

The inorganic fine particles may be internally added to the toner particles or may be mixed with the toner particles as an external additive. Examples of the inorganic fine particles include fine particles, such as silica fine particles, titanium oxide fine particles, alumina fine particles, and double oxide fine particles thereof. Of the inorganic fine particles, silica fine particles and titanium oxide fine particles are preferred from the viewpoints of improving fluidity and uniformizing charge. It is preferred that the inorganic fine particles be hydrophobized with a hydrophobizing agent, such as a silane compound, a silicone oil, or a mixture thereof.

### <External Additive>

In addition to the above-mentioned inorganic fine particles, organic fine particles, such as melamine-based resin fine particles and polytetrafluoroethylene resin fine particles, may be used as the external additive.

From the viewpoint of improving fluidity, the number-based median diameter (D50) of the external additive is preferably 10 nm or more and preferably 250 nm or less, more preferably 200 nm or less, still more preferably 90 nm or less.

The content of the external additive is preferably from 0.1 part by mass to 10.0 parts by mass with respect to 100 parts by mass of the toner particles. A known mixer such as a Henschel mixer may be used in the mixing of the toner particles and the external additive.

### <Developer>

The toner may be used as a one-component developer, but is preferably used as a two-component developer by being be mixed with a magnetic carrier in order to further improve dot reproducibility and to provide stable images over a long period of time.

For example, the following generally known carriers may each be used as the magnetic carrier: iron oxide; particles of metals, such as iron, lithium, calcium, magnesium, nickel, copper, zinc, cobalt, manganese, chromium, and rare earth metals, alloy particles thereof, and oxide particles thereof; a magnetic material such as ferrite; and a magnetic material-dispersed resin carrier (so-called resin carrier) containing a magnetic material and a binder resin holding the magnetic material in a dispersed state.

### <Method of Producing Toner Particles>

A method of producing the toner particles is not particularly limited, and known methods, such as a pulverization method, a suspension polymerization method, a dissolution suspension method, an emulsion aggregation method, and a dispersion polymerization method, may be used. Of those, a pulverization method is preferred from the viewpoint of controlling a wax on the surface of each of the toner particles. That is, the toner particles are preferably pulverized toner particles. A toner production procedure in the pulverization method is described below.

The pulverization method includes, for example: a raw material-mixing step of mixing the crystalline polyester C and the amorphous resin A serving as the binder resin, the phosphorus compound, and the other components, such as other amorphous resins, a wax, a colorant, and a charge control agent, as required; a step of melt-kneading the mixed raw materials to provide a resin composition; and a step of pulverizing the resultant resin composition to provide toner particles.

In the raw material-mixing step, predetermined amounts of, for example, the binder resin, the wax, and as required, other components, such as the colorant and the charge control agent, are weighed, and blended and mixed as materials for forming the toner particles. An example of a mixing apparatus is a double cone mixer, a V-type mixer, a drum-type mixer, a super mixer, a Henschel mixer, a Nauta mixer, or MECHANO HYBRID (manufactured by Nippon Coke & Engineering Co., Ltd.).

Next, the mixed materials are melt-kneaded so that the materials are dispersed in the binder resin. In the melt-kneading step, a batch-type kneader, such as a pressure kneader or a Banbury mixer, or a continuous kneader may be used, and a single-screw or twin-screw extruder has been in the mainstream because of the following superiority: the extruder can perform continuous production. Examples thereof include a KTK-type twin-screw extruder (manufactured by Kobe Steel, Ltd.), a TEM-type twin-screw extruder (manufactured by Toshiba Machine Co., Ltd.), a PCM kneader (manufactured by Ikegai Ironworks Corp.), a twin-screw extruder (manufactured by K.C.K.), a co-kneader (manufactured by Buss), and KNEADEX (manufactured by Nippon Coke & Engineering Co., Ltd.). Further, the resin composition obtained by the melt-kneading may be rolled with a twin-roll mill or the like, and may be cooled with water or the like in a cooling step.

Next, the cooled product of the resin composition is pulverized into a desired particle diameter in the pulverizing step. In the pulverizing step, the cooled product is first coarsely pulverized with a pulverizer, such as a crusher, a hammer mill, or a feather mill. Then, the cooled product is finely pulverized with, for example, KRYPTRON SYSTEM (manufactured by Kawasaki Heavy Industries, Ltd.), SUPER ROTOR (manufactured by Nisshin Engineering Inc.), TURBO MILL (manufactured by Turbo Kogyo Co., Ltd.), or a fine pulverizer based on an air jet system.

After that, as required, the finely pulverized product is classified with a classifier or a sifter, such as: ELBOW-JET (manufactured by Nittetsu Mining Co., Ltd.) based on an inertial classification system, or TURBOPLEX (manufactured by Hosokawa Micron Corporation), TSP SEPARATOR (manufactured by Hosokawa Micron Corporation), or FACULTY (manufactured by Hosokawa Micron Corporation) based on a centrifugal force classification system.

After that, the surfaces of the toner particles are subjected to external addition treatment with an external additive such as silica fine particles as required to provide a toner. As an apparatus for performing the external addition treatment, there is given a mixing apparatus, such as a double cone mixer, a V-type mixer, a drum-type mixer, a super mixer, a Henschel mixer, a Nauta mixer, MECHANO HYBRID (manufactured by Nippon Coke & Engineering Co., Ltd.), or NOBILTA (manufactured by Hosokawa Micron Corporation).

Methods of measuring various physical properties are described below.

(Method of Separating Each Material from Toner)

Each of the materials in the toner may be separated from the toner through utilization of differences between the solubilities of the materials in solvents and GPC. The following various physical properties may be measured through use of each separated material.

First separation: The toner is dissolved in methyl ethyl ketone (MEK) at 23° C. to be separated into soluble matter (the amorphous resin A, an amorphous resin B (used in Examples; the same applies hereinafter), the crystalline polyester C, and the phosphorus compound) and insoluble matter (the wax, the colorant, the inorganic fine particles, and the like).

Second separation: The soluble matter (the amorphous resin A, the amorphous resin B, the crystalline polyester C, and the phosphorus compound) obtained in the first separation is dissolved in tetrahydrofuran (TIF) at 23° C. to be separated into soluble matter (the amorphous resin A, the amorphous resin B, and the phosphorus compound) and insoluble matter (the crystalline polyester C).

Third separation: The insoluble matter (the wax, the colorant, the inorganic fine particles, and the like) obtained in the first separation is dissolved in MEK at 100° C. to be separated into soluble matter (the wax) and insoluble matter (the colorant, the inorganic fine particles, and the like).

Fourth separation: The soluble matter (the amorphous resin A, the amorphous resin B, and the phosphorus compound) obtained in the second separation is dissolved in tetrahydrofuran (TIF) at 23° C. to be separated into the amorphous resin A, the amorphous resin B, and the phosphorus compound by preparative GPC.

### <Identification of Attribution of Various Monomer Units in Amorphous Resin and Crystalline Polyester, and Measurement Method for Content Ratios Thereof>

The identification of attribution of various monomer units in the amorphous resin and the crystalline polyester and the measurement of the content ratios thereof are performed under the following conditions by ¹H-NMR.
Measuring apparatus: FT NMR apparatus JNM-EX400 (manufactured by JEOL Ltd.)
Measurement frequency: 400 MHz
Pulse condition: 5.0 s
Frequency range: 10,500 Hz
Number of scans: 64 times
Measurement temperature: 30° C.
Sample: 50 mg of a measurement sample is loaded into a sample tube having an inner diameter of 5 mm, and deuterated chloroform (CDCl₃) is added as a solvent to the tube. The sample is dissolved in the solvent in a thermostat at 40° C. to prepare a solution.

From the resultant ¹H-NMR chart, the structures of various monomer units are identified, and integrated values S₁, S₂, S₃, . . . Sₙ of peaks attributed to the respective monomer units are calculated.

The content ratio of each of the various monomer units is determined by using the integrated values S₁, S₂, S₃, . . . Sₙ as described below. n₁, n₂, n₃, . . . nₙ represent the numbers of hydrogen atoms in the respective monomer units.

Content ratio of each of various monomer units (mol %)={(Sₙ/nₙ)/((S₁/n₁)+(S₂/n₂)+(S₃/n₃) . . . +(Sₙ/nₙ))}×100

The content ratio of each of the various monomer units (mol %) is calculated by changing the numerator term in the same operation. When such a polymerizable monomer that each of the various monomer units is free of any hydrogen atom is used, the measurement is performed by using ¹³C-NMR through use of ¹³C as a measurement atomic nucleus in a single-pulse mode, and the calculation is performed in the same manner as in ¹H-NMR.

### <Method of Calculating SP Values of Amorphous Resin and Crystalline Polyester>

The SP value of each of the amorphous resin and the crystalline polyester is calculated in accordance with a calculation method proposed by Fedors.

Specifically, the evaporation energy (Δei), molar volume (Δvi), and molar ratio (j) in the resin of each monomer unit are determined. The SP value is calculated through use of the determined values from the following equation.

$$SP value {( cal / {cm}^{3} )}^{0.5} = {\{ ( \sum j \times \sum Δ ei ) / ( \sum j \times \sum Δ vi ) \}}^{0.5}$$

Regarding the evaporation energy (Δei) and molar volume (Δvi) of an atom or an atomic group in the monomer unit, values described in “Polym. Eng. Sci., 14(2), 147-154 (1974)” are used.

### <Method of Measuring Content W_{P} of Phosphorus Elements in Toner>

The content W_{P} (ppm) of the phosphorus elements in the toner is measured with a multi-element simultaneous ICP emission spectrometer Vista-PRO (manufactured by Hitachi High-Tech Science Corporation).
Sample: 50 mg
Solvent: 6 mL of nitric acid

The above-mentioned materials were weighed and subjected to decomposition treatment with a microwave sample pretreatment device ETHOS UP (manufactured by Milestone General K.K.).
Temperature: The temperature is increased from 20° C. to 230° C. and held at 230° C. for 30 minutes.

The decomposed solution is passed through filter paper (5C). After that, the decomposed solution is transferred to a 50 mL measuring flask and diluted to 50 mL with ultrapure water. The content of the phosphorus elements in the toner may be quantified by measuring the aqueous solution in the measuring flask with the multi-element simultaneous ICP emission spectrometer Vista-PRO under the following conditions. In the quantification of the content, a calibration curve is prepared through use of a standard sample of the elements to be quantified, and the content is calculated based on the calibration curve.
Condition: RF power 1.20 kW
Ar gas: Plasma flow 15.0 L/min
Auxiliary flow: 1.50 L/min
MFC: 1.50 L/min
Nebulizer flow: 0.90 L/min
Liquid feed pump speed: 15 rpm
Measurement repetition: 3 times
Measurement time: 1.0 s

### [Electrophotographic Apparatus]

In addition, an electrophotographic apparatus of the present invention is characterized by including the electrophotographic photosensitive member described above, a charging unit, an image exposing unit, a developing unit, a transfer unit, and a cleaning unit.

An example of the schematic configuration of an electrophotographic apparatus including a process cartridge including the electrophotographic photosensitive member is illustrated in FIG. 2.

An electrophotographic photosensitive member 1 having a cylindrical shape is rotationally driven about a shaft 2 in a direction indicated by the arrow at a predetermined peripheral speed. The surface of the electrophotographic photosensitive member 1 is charged to a predetermined positive or negative potential by a charging unit 3. Although a roller charging system based on a roller-type charging member is illustrated in the figure, a charging system, such as a corona charging system, a contact charging system, or an injection charging system, may be adopted. The charged surface of the electrophotographic photosensitive member 1 is irradiated with image exposure light 4 from an image exposing unit (not shown), and hence an electrostatic latent image corresponding to target image information is formed thereon. The electrostatic latent image formed on the surface of the electrophotographic photosensitive member 1 is developed with a toner stored in a developing unit 5, and a toner image is formed on the surface of the electrophotographic photosensitive member 1. The toner image formed on the surface of the electrophotographic photosensitive member 1 is transferred onto a transfer material 7 by a transfer unit 6. The transfer material 7 onto which the toner image has been transferred is conveyed to a fixing unit 8, is subjected to treatment for fixing the toner image, and is printed out to the outside of the electrophotographic apparatus. The electrophotographic apparatus includes a cleaning unit 9 for removing a deposit such as the residual toner remaining on the surface of the electrophotographic photosensitive member 1 after the transfer. The electrophotographic apparatus may include a mechanism (not shown) for supplying a lubricant onto the surface of the electrophotographic photosensitive member. The electrophotographic apparatus may include an electricity-removing mechanism that subjects the surface of the electrophotographic photosensitive member 1 to electricity-removing treatment with pre-exposure light 10 from a pre-exposing unit (not shown). In addition, a guiding unit 12 such as a rail may be arranged in order to removably mount the process cartridge of the present invention onto the main body of an electrophotographic apparatus.

The electrophotographic photosensitive member of the present invention may be used in a laser beam printer, an LED printer, a copying machine, a facsimile, a multifunctional peripheral thereof, and the like.

According to one aspect of the present disclosure, there can be provided an electrophotographic apparatus in which the occurrence of image density unevenness (pattern memory) at the time of repeated use under a high-temperature and high-humidity environment is suppressed.

### EXAMPLES

The present invention is described more specifically below by way of Production Examples and Examples. The present invention is not limited thereto. The numbers of parts in the following formulations are all by mass unless otherwise stated.

### [Production Example of Electrophotographic Photosensitive Member]

### <Production Example of Electrophotographic Photosensitive Member 1>

### Support

An aluminum cylinder having a length of 357.5 mm and an outer diameter of 30 mm was prepared as a support (conductive support).

### Formation of Undercoat Layer

3 Parts by mass of titanium oxide (product name: TTO-55(D), manufactured by Ishihara Sangyo Kaisha, Ltd.) and 2 parts by mass of copolymerized polyamide (nylon) (product name: AMILAN CM8000, manufactured by Toray Industries, Inc.) were added to 25 parts by mass of methyl alcohol, and the mixture was subjected to dispersion treatment with a paint shaker for 8 hours to prepare a coating liquid for an undercoat layer.

The conductive support was immersed in the resultant coating liquid for an undercoat layer and then pulled up. The resultant coat was dried at 100° C. for 20 minutes to form an undercoat layer having a thickness of 1 μm on the conductive support.

### Formation of Charge-Generating Layer

1 Part by mass of titanyl phthalocyanine having a strong peak at a Bragg angle 2θ±0.2° of 27.2° in CuKα characteristic X-ray diffraction serving as a charge-generating substance and 1 part by mass of a butyral resin (product name: S-LEC BM-2(Z), manufactured by Sekisui Chemical Co., Ltd.) serving as a binder were mixed into 98 parts by mass of methyl ethyl ketone, and the mixture was subjected to dispersion treatment with a paint shaker for 8 hours to prepare a coating liquid for forming a charge-generating layer.

The resultant coating liquid for forming a charge-generating layer was applied onto the surface of the undercoat layer arranged in advance by the same method as that in the case of the formation of the undercoat layer, followed by drying at 80° C. for 15 minutes, to form a charge-generating layer having a thickness of 0.3 μm.

### Formation of Charge-Transporting Layer (Surface Layer)

100 Parts by mass of the compound represented by the formula (A) (exemplary compound 2 shown in Table 1) serving as a charge-transporting substance, 90 parts by mass of a polycarbonate resin (TS2050: manufactured by Teijin Chemicals Ltd.), and 10 parts by mass of silica particles (AEROSIL 130: manufactured by Nippon Aerosil Co., Ltd., number-average primary particle diameter: 16 nm) were mixed, and the mixture was suspended in tetrahydrofuran serving as a solvent to produce a suspension. After that, the suspension was subjected to stirring treatment with a ball mill for 15 hours. The resultant mixture was subjected to 1-pass dispersion treatment with a particle dispersion device (model: M-110P, manufactured by Microfluidics) to prepare a coating liquid for a charge-transporting layer.

The resultant coating liquid for a charge-transporting layer was applied onto the charge-generating layer by the same immersion method as that in the case of the formation of the undercoat layer, and the resultant coat was dried at 130° C. for 1 hour to form a charge-transporting layer (surface layer) having a thickness of 30 μm. Thus, an electrophotographic photosensitive member 1 illustrated in FIG. 1 was obtained.

### <Production Example of Electrophotographic Photosensitive Member 2>

An electrophotographic photosensitive member 2 was produced in the same manner as in the production example of the electrophotographic photosensitive member 1 except that the content of the silica particles in the surface layer was changed from 10 parts by mass to 5 parts by mass.

### <Production Example of Electrophotographic Photosensitive Member 3>

An electrophotographic photosensitive member 3 was produced in the same manner as in the production example of the electrophotographic photosensitive member 1 except that the content of the silica particles in the surface layer was changed from 10 parts by mass to 33 parts by mass.

### <Production Example of Electrophotographic Photosensitive Member 4>

An electrophotographic photosensitive member 4 was produced in the same manner as in the production example of the electrophotographic photosensitive member 1 except that the silica particles in the surface layer were changed to AEROSIL 300 (manufactured by Nippon Aerosil Co., Ltd., number-average primary particle diameter: 7 nm).

### <Production Example of Electrophotographic Photosensitive Member 5>

An electrophotographic photosensitive member 5 was produced in the same manner as in the production example of the electrophotographic photosensitive member 1 except that the silica particles in the surface layer were changed to SO-E1 (manufactured by Admatechs Company Limited, number-average primary particle diameter: 300 nm).

### <Production Example of Electrophotographic Photosensitive Member 6>

An electrophotographic photosensitive member 6 was produced in the same manner as in the production example of the electrophotographic photosensitive member 1 except that the compound represented by the formula (A) in the surface layer was changed from the exemplary compound 2 in Table 1 to the exemplary compound 1 in Table 1.

### <Production Example of Electrophotographic Photosensitive Member 7>

An electrophotographic photosensitive member 7 was produced in the same manner as in the production example of the electrophotographic photosensitive member 1 except that the content of the silica particles in the surface layer was changed from 10 parts by mass to 3 parts by mass.

### <Production Example of Electrophotographic Photosensitive Member 8>

An electrophotographic photosensitive member 8 was produced in the same manner as in the production example of the electrophotographic photosensitive member 1 except that the silica particles in the surface layer were changed to SO-E2 (manufactured by Admatechs Company Limited, number-average primary particle diameter: 500 nm).

### <Production Example of Electrophotographic Photosensitive Member 9>

An electrophotographic photosensitive member 9 was produced in the same manner as in the production example of the electrophotographic photosensitive member 1 except that: the content of the exemplary compound 2 in the surface layer was changed from 100 parts by mass to 75 parts by mass; the content of the polycarbonate resin therein was changed from 90 parts by mass to 140 parts by mass; the content of the silica particles therein was changed from 10 parts by mass to 25 parts by mass; and 75 parts by mass of a bistriphenylamine compound represented by the following formula (B) was further added.

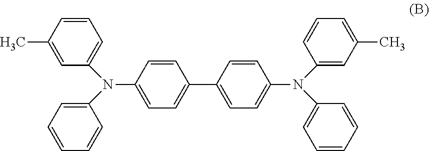

### <Production Example of Electrophotographic Photosensitive Member 10>

An electrophotographic photosensitive member 10 was produced in the same manner as in the production example of the electrophotographic photosensitive member 1 except that the content of the silica particles in the surface layer was changed from 10 parts by mass to 100 parts by mass.

### <Production Example of Electrophotographic Photosensitive Member 11>

An electrophotographic photosensitive member 11 was produced in the same manner as in the production example of the electrophotographic photosensitive member 1 except that: the silica particles in the surface layer were changed to silicone resin particles (X-52-854: manufactured by Shin-Etsu Chemical Co., Ltd., number-average primary particle diameter: 700 nm), and the content thereof was changed from 10 parts by mass to 3 parts by mass.

### <Production Example of Electrophotographic Photosensitive Member 12>

An electrophotographic photosensitive member 12 was produced in the same manner as in the production example of the electrophotographic photosensitive member 1 except that the silica particles in the surface layer were changed to hollow silica particles (SiliNax: manufactured by Nittetsu Mining Co., Ltd., number-average primary particle diameter: 100 nm).

### <Production Example of Electrophotographic Photosensitive Member 13>

An electrophotographic photosensitive member 13 was produced in the same manner as in the production example of the electrophotographic photosensitive member 1 except that the silica particles in the surface layer were not added.

The electrophotographic photosensitive members 1 to 13 produced as described above are shown in Table 2.

TABLE 2

| | Electro- | | | |
|---|---|---|---|---|
| | photographic | | | After passage of |
| | photosensitive | | Pattern | 10,000 sheets |
| | member | Developer | memory | ΔVl [V] |
| Example 1 | 1 | 1 | A | A |
| Example 2 | 2 | 1 | A | A |
| Example 3 | 3 | 1 | A | A |
| Example 4 | 4 | 1 | A | A |
| Example 5 | 5 | 1 | A | A |
| Example 6 | 6 | 1 | A | A |
| Example 7 | 7 | 1 | B | A |
| Example 8 | 8 | 1 | B | A |
| Example 9 | 9 | 1 | A | A |
| Example 10 | 10 | 1 | A | C |
| Example 11 | 11 | 1 | C | A |
| Example 12 | 12 | 1 | A | A |
| Comparative | 13 | 1 | D | A |
| Example 1 | | | | |

### [Production Example 1 of Toner]

### <Measurement Method for Softening Point of Resin>

The softening point of a resin is measured with a constant-pressure extrusion system capillary rheometer (product name: flow characteristic-evaluating device Flowtester CFT-500D, manufactured by Shimadzu Corporation) in accordance with the manual attached to the apparatus. In this apparatus, a measurement sample filled into a cylinder is increased in temperature to be melted while a predetermined load is applied to the measurement sample with a piston from above, and the melted measurement sample is extruded from a die in a bottom part of the cylinder. At this time, a flow curve representing a relationship between a piston descent amount and a temperature can be obtained.

A “melting temperature in a 1/2 method” described in the manual attached to the “flow characteristic-evaluating device Flowtester CFT-500D” is adopted as the softening point. The melting temperature in the 1/2 method is calculated as described below. First, 1/2 of a difference between a descent amount (Smax) of the piston at a time when the outflow is finished and a descent amount (Smin) of the piston at a time when the outflow is started is determined (The 1/2 of the difference is represented by X. X=(Smax−Smin)/2). Then, the temperature when the descent amount of the piston reaches the sum of X and Smin in the flow curve is the melting temperature in the 1/2 method.

The measurement sample to be used is obtained by subjecting about 1.0 g of the resin to compression molding at about 10 MPa for about 60 seconds through use of a tablet compressing machine (e.g., NT-100H, manufactured by NPa SYSTEM Co., Ltd.) under an environment at 25° C. to form the sample into a columnar shape having a diameter of about 8 mm.

The measurement conditions of the CFT-500D are as described below.
Test mode: heating method
Starting temperature: 50° C.
Reached temperature: 200° C.
Measurement interval: 1.0° C.
Rate of temperature increase: 4.0° C./min
Piston sectional area: 1.000 cm²
Test load (piston load): 10.0 kgf/cm² (0.9807 MPa)
Preheating time: 300 seconds
Diameter of hole of die: 1.0 mm
Length of die: 1.0 mm

### Production Example of Resin 1

The following materials were loaded into a reaction vessel with a reflux condenser, a stirring machine, a temperature gauge, and a nitrogen-introducing tube under a nitrogen atmosphere.

| | |
|---|---|
| Propylene oxide adduct of bisphenol A | 100 parts by mass |
| (average number of moles added: 2.2 mol) | |
| Recovered polyethylene terephthalate | 21 parts by mass |
| (content of diethylene glycol = 1.3 mass %) | |
| Dibutyltin oxide | 0.08 part by mass |

A reaction was performed for 7 hours by heating the inside of the reaction vessel to 230° C. under stirring at 200 rpm. Subsequently, the mixture was cooled to 180° C., and 30 parts by mass of fumaric acid and 0.08 part by mass of hydroquinone were loaded into the reaction vessel, followed by heating to 210° C. over 4 hours. After that, the inside of the reaction vessel was reduced in pressure to 8 kPa, and the resultant was subjected to a reaction until the softening point of 103° C. was achieved. Thus, a resin 1 was obtained.

### Production Example of Resin 2

The following materials were loaded into a reaction vessel with a reflux condenser, a stirring machine, a temperature gauge, and a nitrogen-introducing tube under a nitrogen atmosphere.

| | |
|---|---|
| Propylene oxide adduct of bisphenol A | 100 parts by mass |
| (average number of moles added: 2.2 mol) | |
| Ethylene oxide adduct of bisphenol A | 40 parts by mass |
| (average number of moles added: 2.2 mol) | |
| Dodecenylsuccinic anhydride | 13 parts by mass |
| Terephthalic acid | 37 parts by mass |
| Trimellitic anhydride | 12 parts by mass |
| Dibutyltin oxide | 0.5 part by mass |

A reaction was performed for 4 hours by heating the inside of the reaction vessel to 235° C. under stirring at 200 rpm. After that, the inside of the reaction vessel was reduced in pressure to 8 kPa, and the resultant was subjected to a reaction until the softening point of 146° C. was achieved. Thus, a resin 2 was obtained.

### Production Example of Toner Particles 1

| | |
|---|---|
| Resin 1 | 70 parts by mass |
| Resin 2 | 30 parts by mass |
| Colorant ECB-301 (manufactured by | 5 parts by mass |
| Dainichiseika Color & Chemicals Mfg. | |
| Co., Ltd., C.I. Pigment Blue 15:3) | |
| Charge control agent LR-147 | 1 part by mass |
| (manufactured by Japan Carlit Co., Ltd.) | |
| Release agent NP-105 (manufactured by | 4 parts by mass |
| Mitsui Chemicals, Inc., melting point: 140° C.) | |

The above-mentioned materials were mixed with a Henschel mixer (model FM-75, manufactured by Nippon Coke & Engineering Co., Ltd.) at a number of rotations of 20 s⁻¹ for a time of rotation of 5 min. After that, the mixture was kneaded with a twin-screw kneading machine set to a temperature of 120° C. and a number of rotations of a screw of 200 rpm (model PCM-30, manufactured by Ikegai Corp.) at a discharge temperature of 135° C. The kneaded product thus obtained was cooled at a cooling speed of 15° C./min and coarsely pulverized with a hammer mill to 1 mm or less to provide a coarsely pulverized product. The coarsely pulverized product thus obtained was finely pulverized with a mechanical pulverizer (T-250, manufactured by FREUND-Turbo Corporation). Further, the finely pulverized product was classified with Faculty F-300 (manufactured by Hosokawa Micron Corporation) to provide toner particles 1. Operating conditions were as follows: the number of rotations of a classification rotor was set to 130 s⁻¹ and the number of rotations of a dispersion rotor was set to 120 s⁻¹.

### Production Example of Toner 1

The following materials were mixed with a Henschel mixer (model FM-10C, manufactured by Nippon Coke & Engineering Co., Ltd.) at a number of rotations of 30 s⁻¹ for a time of rotation of 10 min to provide a toner 1.

| | |
|---|---|
| Toner particles 1 | 100 parts by mass |
| External additive 1 AEROSIL R-972 | 1.0 part by mass |
| (manufactured by Nippon Aerosil Co., | |
| Ltd., average particle diameter: 16 nm) | |
| External additive 2 SI-Y (manufactured | 1.0 part by mass |
| by Nippon Aerosil Co., Ltd., average | |
| particle diameter: 40 nm) | |

### (Production Example of Magnetic Carrier)

Magnetite 1 having a number-average particle diameter of 0.30 μm (intensity of magnetization under a magnetic field of 1,000/4π (kA/m): 65 Am²/kg)
Magnetite 2 having a number-average particle diameter of 0.50 μm (intensity of magnetization under a magnetic field of 1,000/4π (kA/m): 65 Am²/kg)

4.0 Parts by mass of a silane compound (3-(2-aminoethylaminopropyl)trimethoxysilane) was added to 100 parts of each of the above-mentioned materials, and the materials were mixed and stirred at a high speed at 100° C. or more in a container to treat each of fine particles.
Phenol: 10 mass %
Formaldehyde solution: 6 mass %
   (40 mass % of formaldehyde, 10 mass % of methanol, and 50 mass % of water)
Magnetite 1 treated with the silane compound: 58 mass %
Magnetite 2 treated with the silane compound: 26 mass %

100 Parts of the above-mentioned materials, 5 parts of a 28 mass % ammonia aqueous solution, and 20 parts of water were loaded into a flask, and the temperature in the flask was increased to 85° C. in 30 minutes while the materials were stirred and mixed. The resultant was held for 3 hours to perform a polymerization reaction to cure a generated phenol resin.

After that, the cured phenol resin was cooled to 30° C., and water was further added thereto. Then, the supernatant liquid was removed, and the precipitate was washed with water, followed by air-drying. Then, the resultant was dried at a temperature of 60° C. under reduced pressure (5 mmHg or less) to provide a magnetic material-dispersed spherical magnetic carrier 1. The volume-based 50% particle diameter (D50) of the magnetic carrier 1 was 34 m.

### Production Example of Developer 1

The following materials were mixed with a V-type mixer (V-20, manufactured by Seishin Enterprise Co., Ltd.) to provide a developer 1.

| | |
|---|---|
| Toner 1 | 8 parts by mass |
| Magnetic carrier 1 | 92 parts by mass |

### Example 1

The produced electrophotographic photosensitive member 1 was mounted to a cyan station of a reconstructed machine of an electrophotographic copying machine iR-ADV C560F III manufactured by Canon Inc., and the developer 1 was set in a developing machine as a developer.

### [Evaluation 1: Evaluation of Pattern Memory]

The above-mentioned electrophotographic apparatus was placed under an environment at 32.5° C./85% RH. The conditions of a charging device and an exposing device were set so that the charge potential of the electrophotographic photosensitive member was −600 V and the exposure potential thereof was −200 V, and the conditions of a developing device were set so that the developing potential was −420 V.

As a pattern image to be output, a pattern image including an image having a width of 10 mm and a length of 200 mm in a direction parallel to a sheet passing direction was prepared. Next, the pattern image was continuously output onto 5,000 sheets of A4-size plain paper as a solid image with a density of 100% in cyan monochromatic color. Subsequently, an evaluation was made regarding whether or not a density difference had occurred in an image portion having a width of 10 mm and a length of 200 mm output previously when a full-screen halftone image having a density of 30% was output onto one sheet in cyan monochromatic color. The output image was evaluated based on the following evaluation criteria. The evaluation results are shown in Table 3.

### (Evaluation Criteria of Pattern Memory)

A: No density difference occurs.
B: A density difference occurs to the extent that whether or not the density difference is present cannot be determined.
C: A slight density difference occurs (acceptable level in the present invention).
D: A clear density difference occurs (unacceptable level in the present invention).

### [Evaluation 2: Evaluation of Potential Fluctuation at Time of Repeated Use]

The above-mentioned electrophotographic apparatus was placed under an environment at 23° C./50% RH. The conditions of a charging device and an exposing device were set so that the charge potential of the electrophotographic photosensitive member was −600 V and the exposure potential thereof was −200 V, and the conditions of a developing device were set so that the developing potential was −420 V.

A character image having a print percentage of 1% was repeatedly formed on 10,000 sheets of A4-size plain paper in monochromatic color in a cyan station in which the electrophotographic photosensitive member was set. An initial exposure potential was compared to an exposure potential after the repeated formation of the image on the 10,000 sheets, and the difference therebetween was defined as a value (ΔVl) of potential fluctuation. After the completion of the passage of the 10,000 sheets, the apparatus was left for 5 minutes, and a cartridge for development was replaced with a potential measuring device. Then, an exposure potential (Vlb) after repeated use was measured. The difference between the exposure potential after the repeated use and an initial exposure potential (Vla) was defined as an exposure potential fluctuation amount (ΔVl=|Vlb|−|Vla|).

The results of the evaluation based on the following evaluation criteria are shown in Table 3.

### (Evaluation Criteria of ΔVl)

A: The ΔVl is 0 V or more and less than 30 V (excellent).
B: The ΔVl is 30 V or more and less than 40 V (slightly excellent).
C: The ΔVl is 40 V or more and less than 50 V (acceptable level in the present invention).
D: The ΔVl is 50 V or more (unacceptable level in the present invention).

### Examples 2 to 12 and Comparative Example 1

Electrophotographic apparatus were each evaluated in the same manner as in Example 1 except that the kinds of the electrophotographic photosensitive member and the developer were changed as shown in Table 3. The evaluation results are shown in Table 3.

TABLE 3

| | Electro- | | | |
|---|---|---|---|---|
| | photographic | | | After passage of |
| | photosensitive | | Pattern | 10,000 sheets |
| | member | Developer | memory | ΔVl [V] |
| Example 1 | 1 | 1 | A | A |
| Example 2 | 2 | 1 | A | A |
| Example 3 | 3 | 1 | A | A |
| Example 4 | 4 | 1 | A | A |
| Example 5 | 5 | 1 | A | A |
| Example 6 | 6 | 1 | A | A |
| Example 7 | 7 | 1 | B | A |
| Example 8 | 8 | 1 | B | A |
| Example 9 | 9 | 1 | A | A |
| Example 10 | 10 | 1 | A | C |
| Example 11 | 11 | 1 | C | A |
| Example 12 | 12 | 1 | A | A |
| Comparative | 13 | 1 | D | A |
| Example 1 | | | | |

### Production Example 2 of Toner

### <Production of Amorphous Resin A1>

Polyethylene terephthalate (molecular weight: 2,000, intrinsic viscosity: 0.1): 20.9 parts (42.0 mol %)
Propylene oxide adduct of bisphenol A (average number of moles added: 2.0 mol): 47.4 parts (29.0 mol %)
Terephthalic acid: 15.8 parts (18.3 mol %)
Dodecenylsuccinic acid: 15.8 parts (10.6 mol %)
Titanium tetrabutoxide (esterification catalyst): 0.5 part
Gallic acid (promoter): 0.1 part

The above-mentioned materials were weighed in a reaction vessel with a condenser, a stirring machine, a nitrogen-introducing tube, and a thermocouple. The molar ratio of polyethylene terephthalate is a value as the number of units obtained by adding up the number of units derived from ethylene glycol and the number of units derived from terephthalic acid.

Next, the flask was purged with a nitrogen gas, and then the temperature therein was gradually increased while the materials were stirred. The materials were subjected to a reaction for 2 hours while being stirred at a temperature of 200° C.

Further, the materials were subjected to a reaction for 5 hours while the pressure in the reaction vessel was reduced to 8.3 kPa and the temperature therein was maintained at 200° C. After it was confirmed that the weight-average molecular weight reached 6,700, the temperature was reduced so that the reaction was stopped. Thus, an amorphous resin A1 having a polyethylene terephthalate segment in a molecule thereof was obtained. The physical property of the amorphous resin A1 obtained by the above-mentioned measurement method is shown in Table 4-1.

### <Production of Amorphous Resins A2 to A11>

Amorphous resins A2 to A11 each having a polyethylene terephthalate segment in a molecule thereof were each obtained by performing a reaction in the same manner as in the production of the amorphous resin A1 except that the kinds and numbers of parts of polyethylene terephthalate and polymerizable monomers were changed as shown in Tables 4-1 to 4-4. The physical properties of the amorphous resins A2 to A11 obtained by the above-mentioned measurement method are shown in Tables 4-1 to 4-4.

TABLE 4-1

| | | Amorphous | | Amorphous | | Amorphous | |
|---|---|---|---|---|---|---|---|
| | | resin A1 | | resin A2 | | resin A3 | |
| | | Number | | Number | | Number | |
| | | of parts | mol % | of parts | mol % | of parts | mol % |
| Polyethylene terephthalate | | 20.9 | 42.0 | 11.0 | 24.9 | 27.0 | 49.9 |
| Alcohol | BPA-PO | 47.4 | 29.0 | 53.4 | 37.6 | 43.8 | 25.1 |
| component | BPA-EO | | | | | | |
| Carboxylic | Terephthalic acid | 15.8 | 18.3 | 17.8 | 23.7 | 14.6 | 15.8 |
| acid | Dodecenylsuccinic | 15.8 | 10.6 | 17.8 | 13.8 | 14.6 | 9.2 |
| component | acid | | | | | | |
| | Tetradecanedioic | | | | | | |
| | acid | | | | | | |
| | Suberic acid | | | | | | |
| | Octadecanedioic | | | | | | |
| | acid | | | | | | |
| | Adipic acid | | | | | | |
| | Eicosanedioic acid | | | | | | |
| | Trimellitic acid | | | | | | |
| Physical | SP | 11.30 | | 11.10 | | 11.44 | |
| property | | | | | | | |

TABLE 4-2

| | | Amorphous | | Amorphous | | Amorphous | |
|---|---|---|---|---|---|---|---|
| | | resin A4 | | resin A5 | | resin A6 | |
| | | Number | | Number | | Number | |
| | | of parts | mol % | of parts | mol % | of parts | mol % |
| Polyethylene terephthalate | | 22.7 | 43.1 | 22.6 | 41.1 | 23.0 | 44.7 |
| Alcohol | BPA-PO | 50.6 | 29.8 | 55.0 | 29.5 | 52.2 | 30.9 |
| component | BPA-EO | | | | | | |
| Carboxylic | Terephthalic acid | 16.9 | 18.8 | 5.5 | 5.6 | 17.4 | 19.5 |
| acid | Dodecenylsuccinic | | | | | | |
| component | acid | | | | | | |
| | Tetradecanedioic | 10.1 | 8.3 | | | | |
| | acid | | | | | | |
| | Suberic acid | | | 16.0 | 23.8 | | |
| | Octadecanedioic | | | | | 7.4 | 4.9 |
| | acid | | | | | | |
| | Adipic acid | | | | | | |
| | Eicosanedioic acid | | | | | | |
| | Trimellitic acid | | | | | | |
| Physical | SP | 11.30 | | 11.30 | | 11.30 | |
| property | | | | | | | |

TABLE 4-3

| | | Amorphous | | Amorphous | | Amorphous | |
|---|---|---|---|---|---|---|---|
| | | resin A7 | | resin A8 | | resin A9 | |
| | | Number | | Number | | Number | |
| | | of parts | mol % | of parts | mol % | of parts | mol % |
| Polyethylene terephthalate | | 10.0 | 22.9 | 28.5 | 51.7 | 22.6 | 41.1 |
| Alcohol | BPA-PO | 54.0 | 38.6 | 42.9 | 24.2 | 55.0 | 29.5 |
| component | BPA-EO | | | | | | |
| Carboxylic | Terephthalic acid | 18.0 | 24.3 | 14.3 | 15.2 | 5.5 | 5.6 |
| acid | Dodecenylsuccinic | 18.0 | 14.1 | 14.3 | 8.9 | | |
| component | acid | | | | | | |
| | Tetradecanedioic | | | | | | |
| | acid | | | | | | |
| | Suberic acid | | | | | | |
| | Octadecanedioic | | | | | | |
| | acid | | | | | | |
| | Adipic acid | | | | | 16.0 | 23.8 |
| | Eicosanedioic acid | | | | | | |
| | Trimellitic acid | | | | | | |
| Physical | SP | 11.08 | | 11.47 | | 11.30 | |
| property | | | | | | | |

TABLE 4-4

| | | Amorphous | | Amorphous | |
|---|---|---|---|---|---|
| | | resin A10 | | resin A11 | |
| | | Number | | Number | |
| | | of parts | mol % | of parts | mol % |
| Polyethylene terephthalate | | 23.0 | 45.1 | 28.7 | 55.7 |
| Alcohol | BPA-PO | 52.4 | 31.1 | 36.6 | 21.7 |
| component | BPA-EO | | | 14.6 | 9.5 |
| Carboxylic | Terephthalic acid | 17.5 | 19.6 | 2.2 | 2.5 |
| acid | Dodecenylsuccinic | | | 9.3 | 6.1 |
| component | acid | | | | |
| | Tetradecanedioic | | | | |
| | acid | | | | |
| | Suberic acid | | | | |
| | Octadecanedioic | | | | |
| | acid | | | | |
| | Adipic acid | | | | |
| | Eicosanedioic acid | 7.0 | 4.2 | | |
| | Trimellitic acid | | | 8.6 | 4.5 |
| Physical | SP | 11.30 | | 11.45 | |
| property | | | | | |

The abbreviations in Tables 4-1 to 4-4 are as described below.
BPA-PO: propylene oxide adduct of bisphenol A (average number of moles added: 2.0 mol)

### <Production of Amorphous Resin B1>

Polyethylene terephthalate (molecular weight: 2,000, intrinsic viscosity: 0.1): 4.1 parts (9.8 mol %)
Propylene oxide adduct of bisphenol A (average number of moles added: 2.0 mol): 57.8 parts (42.8 mol %)
Terephthalic acid: 29.9 parts (41.9 mol %)
Trimellitic acid: 7.0 parts (4.5 mol %)
Stearic acid: 1.2 parts (1.0 mol %)
Titanium tetrabutoxide (esterification catalyst): 0.5 part
Gallic acid (promoter): 0.1 part

The above-mentioned materials were weighed in a reaction vessel with a condenser, a stirring machine, a nitrogen-introducing tube, and a thermocouple. Next, the flask was purged with a nitrogen gas, and then the temperature therein was gradually increased while the materials were stirred. The materials were subjected to a reaction for 2 hours while being stirred at a temperature of 200° C.

Further, the materials were subjected to a reaction for 5 hours while the pressure in the reaction vessel was reduced to 8.3 kPa and the temperature therein was maintained at 200° C. After it was confirmed that the weight-average molecular weight reached 1,000, the temperature was reduced so that the reaction was stopped. Thus, an amorphous resin B1 was obtained. The physical property of the amorphous resin B1 obtained by the above-mentioned measurement method was an SP value of 11.54 (cal/cm³)^{0.5}.

### <Production of Crystalline Polyester C1>

Ethylene glycol: 10.2 parts (48.2 mol %)
Tetradecanedioic acid: 81.3 parts (48.3 mol %)
Behenic acid: 8.5 parts (3.5 mol %)
Titanium tetrabutoxide (esterification catalyst): 0.5 part

The above-mentioned materials were weighed in a reaction vessel with a condenser, a stirring machine, a nitrogen-introducing tube, and a thermocouple. Next, the flask was purged with a nitrogen gas, and then the temperature therein was gradually increased while the materials were stirred. The materials were subjected to a reaction for 2 hours while being stirred at a temperature of 200° C.

Further, the materials were subjected to a reaction for 5 hours while the pressure in the reaction vessel was reduced to 8.3 kPa and the temperature therein was maintained at 200° C. After that, the temperature was reduced so that the reaction was stopped. Thus, a crystalline polyester C1 was obtained. The physical property of the crystalline polyester C1 obtained by the above-mentioned measurement method was an SP value of 10.09 (cal/cm³)^{0.5}.

### <Production Example of Toner 2>

Amorphous resin A1: 66 parts
Amorphous resin B1: 34 parts
Crystalline polyester C1: 10 parts
Fischer-Tropsch wax (peak temperature of maximum endothermic peak: 100° C.): 5 parts
Carbon black: 5 parts
Trisodium phosphate: 0.03 part

The above-mentioned materials were mixed with a Henschel mixer (model FM-75, manufactured by Mitsui Mining Co., Ltd.) at a number of rotations of 1,500 rpm for a time of rotation of 5 min, and then the mixture was kneaded with a twin-screw kneading machine set to a temperature of 130° C. (model PCM-30, manufactured by Ikegai Corp.). The kneaded product thus obtained was cooled and coarsely pulverized with a hammer mill to 1 mm or less to provide a coarsely pulverized product. The coarsely pulverized product thus obtained was finely pulverized with a mechanical pulverizer (T-250, manufactured by Turbo Kogyo Co., Ltd.). Further, the finely pulverized product was classified with Faculty (F-300, manufactured by Hosokawa Micron Corporation) to provide toner particles 1. Operating conditions were as follows: the number of rotations of a classification rotor was set to 11,000 rpm and the number of rotations of a dispersion rotor was set to 7,200 rpm.

| | | |
|---|---|---|
| Toner particles 1: | 95 | parts |
| Large-particle-diameter inorganic fine particles: | 4 | parts |
| fumed silica subjected to surface treatment with | | |
| hexamethyldisilazane (number-based median diameter | | |
| (D50): 120 nm) | | |
| Small-particle-diameter inorganic fine particles: | 1 | part |
| titanium oxide fine particles subjected to | | |

surface treatment with isobutyltrimethoxysilane
(number-based median diameter (D50): 10 nm)

The above-mentioned materials were mixed with a Henschel mixer (model FM-75, manufactured by Mitsui Miike Chemical Engineering Machinery, Co., Ltd.) at a number of rotations of 1,900 rpm for a time of rotation of 10 min to provide a toner 2 showing negative chargeability. The physical properties of the toner 2 obtained by the above-mentioned measurement method are shown in Table 5.

### <Production Examples of Toners 3 to 19>

Toners 3 to 9 were each obtained by performing the same operation as that in the production example of the toner 2 except that the kinds and numbers of parts of the amorphous resin A and the additive were changed as shown in Table 5 in the production example of the toner 2. The physical properties of the toners 3 to 19 each obtained by the above-mentioned measurement method are shown in Table 5.

TABLE 5

| | Internal addition formulation and physical properties | | | | | | | | | |
|---|---|---|---|---|---|---|---|---|---|---|
| Toner | Amorphous resin A | | Amorphous resin B | | Crystalline polyester C | | Additive | | W_{P} | SP_{A}-SP_{C} |
| Kind | Kind | Part(s) | Kind | Part(s) | Kind | Part(s) | Kind | Part(s) | ppm | — |
| 2 | 1 | 66 | 1 | 34 | 1 | 10 | PNa | 0.160 | 250 | 1.21 |
| 3 | 2 | 66 | 1 | 34 | 1 | 10 | PNa | 0.160 | 250 | 1.01 |
| 4 | 3 | 66 | 1 | 34 | 1 | 10 | PNa | 0.160 | 250 | 1.35 |
| 5 | 1 | 66 | 1 | 34 | 1 | 10 | PNa | 0.320 | 500 | 1.21 |
| 6 | 1 | 66 | 1 | 34 | 1 | 10 | PNa | 0.015 | 20 | 1.21 |
| 7 | 1 | 66 | 1 | 34 | 1 | 10 | PF | 0.320 | 250 | 1.21 |
| 8 | 4 | 66 | 1 | 34 | 1 | 10 | PNa | 0.160 | 250 | 1.21 |
| 9 | 5 | 66 | 1 | 34 | 1 | 10 | PNa | 0.160 | 250 | 1.21 |
| 10 | 6 | 66 | 1 | 34 | 1 | 10 | PNa | 0.160 | 250 | 1.21 |
| 11 | 7 | 66 | 1 | 34 | 1 | 10 | PNa | 0.160 | 250 | 0.99 |
| 12 | 8 | 66 | 1 | 34 | 1 | 10 | PNa | 0.160 | 250 | 1.38 |
| 13 | 1 | 66 | 1 | 34 | 1 | 10 | PNa | 0.400 | 600 | 1.21 |
| 14 | 1 | 66 | 1 | 34 | 1 | 10 | — | — | 0 | 1.21 |
| 15 | 9 | 66 | 1 | 34 | 1 | 10 | PNa | 0.160 | 250 | 1.21 |
| 16 | 10 | 66 | 1 | 34 | 1 | 10 | PNa | 0.160 | 250 | 1.21 |
| 17 | 11 | 66 | 1 | 34 | 1 | 10 | PNa | 0.160 | 250 | 1.36 |
| 18 | 1 | 66 | 1 | 34 | 1 | 10 | PNa | 0.004 | 5 | 1.21 |
| 19 | 1 | 66 | 1 | 34 | 1 | 10 | PNa | 0.002 | 3 | 1.21 |

The abbreviations in Table 5 are as described below.
PNa: trisodium phosphate

### Production Examples of Developers 2 to 19

Developers 2 to 19 were each obtained by performing the same operation as that in the production example of the developer 1 except that the kind of the toner was changed as shown in Table 6.

TABLE 6

| Developer Kind | Toner Kind | Carrier Kind |
|---|---|---|
| 2 | 2 | 1 |
| 3 | 3 | 1 |
| 4 | 4 | 1 |
| 5 | 5 | 1 |
| 6 | 6 | 1 |
| 7 | 7 | 1 |
| 8 | 8 | 1 |
| 9 | 9 | 1 |
| 10 | 10 | 1 |
| 11 | 11 | 1 |
| 12 | 12 | 1 |
| 13 | 13 | 1 |
| 14 | 14 | 1 |
| 15 | 15 | 1 |
| 16 | 16 | 1 |
| 17 | 17 | 1 |
| 18 | 18 | 1 |
| 19 | 19 | 1 |

### Examples 13 to 30

The evaluation of each of the electrophotographic apparatus was performed in the same manner as in Example 1 except that the kinds of the electrophotographic photosensitive member and the developer were changed as shown in Tables 7-1 and 7-2. In addition, the evaluation of each of scratch resistance and low-temperature fixability was also performed by the following method. The evaluation results are shown in Tables 7-1 and 7-2.

### [Evaluation 3: Scratch Resistance]

A reconstructed machine of a printer for digital commercial printing “imagePRESS C800” manufactured by Canon Inc. was used as an image-forming apparatus. A two-component developer 1 was loaded into a developing device for cyan. As the reconstructed points of the apparatus, changes were made so that its fixation temperature and process speed, the DC voltage V_{DC} of a developer-carrying member, the charging voltage V_{D} of the electrophotographic photosensitive member, and laser power were able to be freely set. An image output evaluation was performed as follows: an FFh image (solid image) having a desired image print percentage was output and subjected to evaluations to be described later with the V_{DC}, the V_{D}, and the laser power being adjusted so as to achieve a desired toner laid-on level on the FFh image on paper. FFh is a value obtained by representing 256 gradations in hexadecimal notation; 00h represents the first gradation (white portion) of the 256 gradations, and FFh represents the 256th gradation (solid portion) of the 256 gradations.
Paper: UPM FINESSE GLOSS 300GSM
Toner laid-on level on paper: 0.05 mg/cm² (2Fh image)
(The toner laid-on level was adjusted based on the DC voltage V_{DC} of the developer-carrying member, the charging voltage V_{D} of the electrophotographic photosensitive member, and the laser power.)
Evaluation image: An image measuring 3 cm×15 cm was arranged at the center of the above-mentioned A4 paper.
Fixing test environment: Normal-temperature and normal-humidity environment (temperature of 23° C./humidity of 50% RH (hereinafter referred to as “N/N”))
Fixing temperature: 180° C.
Process speed: 377 mm/sec

The above-mentioned evaluation image was output and evaluated for scratch resistance. Specifically, through use of a surface property tester HEIDON TYPE 14FW manufactured by SHINTO Scientific Co., Ltd., a 200 g weight was placed on the surface of the image, the surface was scratched with a needle having a diameter of 0.75 mm at a speed of 60 mm/min and a length of 30 mm, and the image was evaluated based on the scratches that appeared thereon. The area ratio of toner peeling was determined by binarizing the area in which the toner peeling occurred with respect to the scratched area by image processing.

### (Evaluation Criteria)

A: 0.0%
B: 0.1% or more and less than 0.4%
C: 0.4% or more and less than 0.9%
D: 0.9% or more and less than 1.1%
E: 1.1% or more

### [Low-Temperature Fixability]

Paper: GFC-081 (81.0 g/m²) (sold from Canon Marketing Japan Inc.)
Toner laid-on level on paper: 0.50 mg/cm²
(The toner laid-on level was adjusted based on the DC voltage V_{DC} of the developer-carrying member, the charging voltage V_{D} of the electrophotographic photosensitive member, and the laser power.)
Evaluation image: An image measuring 2 cm×5 cm was arranged at the center of the above-mentioned A4 paper.
Test environment: Low-temperature and low-humidity environment: temperature of 15° C./humidity of 10% RH (hereinafter referred to as “L/L”)
Fixing temperature: 150° C.
Process speed: 630 mm/sec

The evaluation image was output and evaluated for low-temperature fixability. The value of an image density reduction ratio was used as an indicator for evaluating the low-temperature fixability.

Through use of an X-Rite color reflection densitometer (500 SERIES: manufactured by X-Rite, Inc.), the image density at the central portion of the image was measured first. Next, the fixed image was rubbed (back and forth 5 times) with lens-cleaning paper with the application of a load of 4.9 kPa (50 g/cm²) to the portion at which the image density was measured, and the image density was measured again.

Then, the reduction ratio of the image density after the rubbing as compared to that before the rubbing was calculated by using the following equation. The resultant image density reduction ratio was evaluated in accordance with the following evaluation criteria. A case of being evaluated as A to C was judged to be satisfactory.

Image density reduction ratio (%)=(image density before rubbing-image density after rubbing)/image density before rubbing×100

### (Evaluation Criteria)

A: An image density reduction ratio of less than 3%
B: An image density reduction ratio of 3% or more and less than 5%
C: An image density reduction ratio of 5% or more and less than 8%
D: An image density reduction ratio of 8% or more and less than 10%
E: An image density reduction ratio of 10% or more

TABLE 7-1

| | Electro- | | | | |
|---|---|---|---|---|---|
| | photographic | | | | |
| | photosensitive | | | | |
| | member | Developer | Toner | Carrier | Pattern |
| | Kind | Kind | Kind | Kind | memory |
| Example 13 | 1 | 2 | 2 | 1 | A |
| Example 14 | 1 | 3 | 3 | 1 | A |
| Example 15 | 1 | 4 | 4 | 1 | A |
| Example 16 | 1 | 5 | 5 | 1 | A |
| Example 17 | 1 | 6 | 6 | 1 | A |
| Example 18 | 1 | 7 | 7 | 1 | A |
| Example 19 | 1 | 8 | 8 | 1 | A |
| Example 20 | 1 | 9 | 9 | 1 | A |
| Example 21 | 1 | 10 | 10 | 1 | A |
| Example 22 | 1 | 11 | 11 | 1 | A |
| Example 23 | 1 | 12 | 12 | 1 | A |
| Example 24 | 1 | 13 | 13 | 1 | A |
| Example 25 | 1 | 14 | 14 | 1 | A |
| Example 26 | 1 | 15 | 15 | 1 | A |
| Example 27 | 1 | 16 | 16 | 1 | A |
| Example 28 | 1 | 17 | 17 | 1 | A |
| Example 29 | 1 | 18 | 18 | 1 | A |
| Example 30 | 1 | 19 | 19 | 1 | A |

TABLE 7-2

| | | Low-temperature fixability | | | | | |
|---|---|---|---|---|---|---|---|
| | | | Image | Image | | Scratch | |
| | After passage | | density | density | | resistance | |
| | of 10,000 | | before | after | Reduction | | Reflectivity |
| | sheets AVI [V] | | rubbing | rubbing | ratio | | difference |
| Example 13 | A | A | 1.35 | 1.32 | 2% | A | 0.0% |
| Example 14 | A | A | 1.35 | 1.32 | 2% | D | 1.0% |
| Example 15 | A | C | 1.35 | 1.28 | 5% | D | 1.0% |
| Example 16 | A | D | 1.35 | 1.23 | 9% | C | 0.8% |
| Example 17 | A | A | 1.35 | 1.32 | 2% | D | 1.0% |
| Example 18 | A | A | 1.35 | 1.32 | 2% | C | 0.7% |
| Example 19 | A | B | 1.35 | 1.31 | 3% | B | 0.3% |
| Example 20 | A | C | 1.35 | 1.28 | 5% | C | 0.8% |
| Example 21 | A | A | 1.35 | 1.32 | 2% | D | 1.0% |
| Example 22 | A | A | 1.35 | 1.32 | 2% | E | 1.3% |
| Example 23 | A | E | 1.35 | 1.21 | 10% | E | 1.3% |
| Example 24 | A | E | 1.35 | 1.21 | 10% | E | 1.2% |
| Example 25 | A | A | 1.35 | 1.32 | 2% | E | 1.2% |
| Example 26 | A | E | 1.35 | 1.21 | 10% | E | 1.2% |
| Example 27 | A | A | 1.35 | 1.32 | 2% | E | 1.2% |
| Example 28 | A | E | 1.35 | 1.21 | 10% | E | 1.3% |
| Example 29 | A | A | 1.35 | 1.32 | 2% | D | 1.0% |
| Example 30 | A | A | 1.35 | 1.32 | 2% | E | 1.1% |

In the toner to be used in the electrophotographic apparatus of the present disclosure, polyethylene terephthalate regenerated from a spent PET bottle or the like can be used as a toner material, and hence the technologies described in this specification have the potential to contribute to the achievement of a sustainable society, such as a decarbonized society/circular society.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-000891, filed Jan. 5, 2024 and Japanese Patent Application No. 2024-176752, filed Oct. 8, 2024, which are hereby incorporated by reference herein in their entirety.

What is claimed is:

1. An electrophotographic apparatus comprising:
an electrophotographic photosensitive member;
a charging unit configured to charge a surface of the electrophotographic photosensitive member;
an image exposing unit configured to irradiate the charged surface of the electrophotographic photosensitive member with image exposure light to form an electrostatic latent image on the surface of the electrophotographic photosensitive member;
a developing unit, which includes a toner, and which is configured to develop the electrostatic latent image with the toner to form a toner image on the surface of the electrophotographic photosensitive member;
a transfer unit configured to transfer the toner image from the surface of the electrophotographic photosensitive member onto a transfer material; and
a cleaning unit configured to remove a residual toner remaining on the surface of the electrophotographic photosensitive member after the toner image is transferred from the surface of the electrophotographic photosensitive member onto the transfer material,
wherein the electrophotographic photosensitive member includes a surface layer containing a compound represented by the following formula (A), a binder resin, and silicon atom-containing particles,
wherein the silicon atom-containing particles are one of silica particles or silicone resin particles, and
wherein the toner includes toner particles each containing a polyester resin having a polyethylene terephthalate segment: 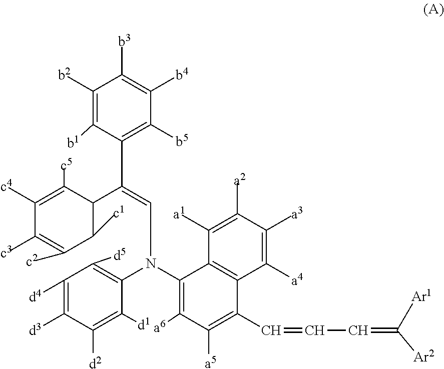
in the formula (A), a¹ to a⁶ each independently represent a hydrogen atom, a halogen atom, a substituted or unsubstituted alkyl group, a substituted or unsubstituted alkoxy group, a dialkylamino group, or a substituted or unsubstituted aryl group, or may be bonded to each other to form a ring structure, b¹ to b⁵, c¹ to c⁵, and d¹ to d⁵ each independently represent a hydrogen atom, a halogen atom, a substituted or unsubstituted alkyl group, a substituted or unsubstituted alkoxy group, a dialkylamino group, a substituted or unsubstituted aryl group, a substituted or unsubstituted aryloxy group, or a substituted or unsubstituted arylthio group, or may be bonded to each other to form a ring structure, and Ar¹ and Ar² each independently represent a hydrogen atom, a substituted or unsubstituted alkyl group, a substituted or unsubstituted aryl group, a substituted or unsubstituted aralkyl group, or a substituted or unsubstituted heterocyclic group, or may be bonded to each other to form a ring structure, provided that Ar¹ and Ar² are prevented from both representing hydrogen atoms.

2. The electrophotographic apparatus according to claim 1, wherein a mass ratio between the compound represented by the formula (A) and the silicon atom-containing particles in the surface layer is from 3:1 to 20:1.

3. The electrophotographic apparatus according to claim 1, wherein the silicon atom-containing particles are silica particles.

4. The electrophotographic apparatus according to claim 1, wherein the silicon atom-containing particles have a number-average primary particle diameter of 5 nm or more and 300 nm or less.

5. The electrophotographic apparatus according to claim 1,
wherein the toner is a toner including toner particles each containing a binder resin,
wherein the binder resin contains an amorphous resin A and a crystalline polyester C,
wherein the amorphous resin A is the polyester resin and has, as structures for forming a polyester backbone,
(i) the polyethylene terephthalate segment, and
(ii) at least one structure selected from the group consisting of units represented by the following formulae (1) to (4): 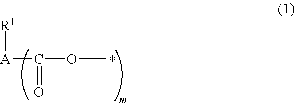
where R¹ represents an alkyl group having 6 to 16 carbon atoms or an alkenyl group having 6 to 16 carbon atoms,
A represents a hydrocarbon group,
“*” represents a bonding site in the polyester backbone, and
“m” represents an integer of 2 or more; 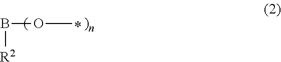
where R² represents an alkyl group having 6 to 16 carbon atoms or an alkenyl group having 6 to 16 carbon atoms,
B represents a hydrocarbon group,
“*” represents a bonding site in the polyester backbone, and
“n” represents an integer of 2 or more; 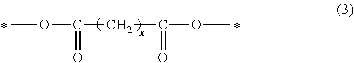
where “*” represents a bonding site in the polyester backbone, and
“x” represents an integer of from 6 to 16; 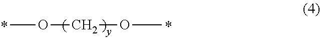
where “*” represents a bonding site in the polyester backbone, and
“y” represents an integer of from 6 to 16,
wherein, when an SP value of the amorphous resin A is represented by SP_{A} (cal/cm³)^{0.5}, and an SP value of the crystalline polyester C is represented by SP_{C} (cal/cm³)^{0.5}, the SP_{A} and the SP_{C} satisfy the following formula (C):
$$1. 00 \leq {SP}_{A} - {SP}_{C} \leq 1.35 , \qquad ( C )$$
wherein the toner contains a phosphorus element derived from a phosphorus compound, and
wherein, when a content of the phosphorus element in the toner based on a mass of the toner is represented by W_{P} (ppm), the W_{P} satisfies the following formula (D):
$$5 \leq {W}_{P} \leq 500 . \qquad ( D )$$

6. The electrophotographic apparatus according to claim 5, wherein the W_{P} satisfies the following formula (E):
$$20 \leq {W}_{P} \leq 500 . \qquad ( E )$$
